(19) United States
(12) Patent Application Publication
(10) Pub. No.: US 2025/0277892 A1
(43) Pub. Date: Sep. 4, 2025

(54) DEVICE DETECTION SYSTEM

(71) Applicant: SiLC Technologies, Inc., Monrovia, CA (US)

(72) Inventors: Mehdi Asghari, La Canada Flintridge, CA (US); Nirmal Chindhu Warke, Saratoga, CA (US); Prakash Koonath, La Crescenta, CA (US)

(21) Appl. No.: 18/595,334

(22) Filed: Mar. 4, 2024

(51) Int. Cl. G01S 7/48; G01S 7/4915; G01S 17/32; G01S 17/58; G01S 17/933

(52) U.S. Cl. CPC G01S 7/4802; G01S 7/4808; G01S 7/4915; G01S 17/32; G01S 17/58; G01S 17/933

(57) ABSTRACT

The device detection system includes a preliminary LIDAR system configured to concurrently output multiple system output signals and scan the system output signals across a detection space. The preliminary LIDAR system calculates preliminary LIDAR data for multiple different scan zones within the detection space. The preliminary LIDAR data for a scan zone indicates the radial velocity between an object in the scan zone and the one or more LIDAR systems. The preliminary LIDAR system processes the preliminary LIDAR data so as to identify a subject one of the scan zones that contains the object. The device detection system also includes a secondary LIDAR system configured to transmit one or more system output signals and to scan the one or more system output signals across the subject scan zone. The secondary LIDAR system calculates LIDAR data for multiple data regions. Each of the data regions at least partially overlaps the subject scan zone. The LIDAR data for each data region indicates the radial velocity and/or the distance between the object in the data region and the secondary LIDAR system.

### FIELD

The invention relates to imaging systems. In particular, the invention relates to imaging systems for detection of objects.

### BACKGROUND

The use of airborne devices such as Unmanned Aerial Vehicles (UAVs) has been increasing. The increased use of these devices has created a demand for technologies that can identify the presence of these devices within certain spaces. For instance, there is an increased demand for systems that can detect the presence of UAVs in the space around airports and other facilities.

The detection of airborne devices has several challenges. For instance, an airborne device becoming closer to the ground increases the number of objects that obscure airborne devices to technologies such as radar. Additionally, objects such as birds are a frequent source of detection errors. As a result, there is a need for a new system for the detection of airborne devices.

### SUMMARY

A LIDAR system is configured to output a system output signal having a divergence angle greater than or equal to 0.1°. The LIDAR system being configured to receive a system return signal, that includes light from the system output signal after the system output signal was reflected by an object located outside of the LIDAR system. The LIDAR system also include light combiners that each combine light from the system return signal with light from a reference signal so as to generate a composite light signal beating at a beat frequency.

A LIDAR system is configured to output a system output signal such that at a distance of 1 km from the LIDAR system, the width of the system output signal is more than 10 m. The LIDAR system being configured to receive a system return signal, that includes light from the system output signal after the system output signal was reflected by an object located outside of the LIDAR system. The LIDAR system also include light combiners that each combine light from the system return signal with light from a reference signal so as to generate a composite light signal beating at a beat frequency.

A device detection system includes a LIDAR system configured to concurrently output multiple system output signals and scan the system output signals across a detection space. The LIDAR system is configured to calculate LIDAR data for multiple different scan zones within the detection space. The LIDAR data for a scan zone indicates a radial velocity between an object in the scan zone and the LIDAR data. The LIDAR system includes a LIDAR data processor configured to process the preliminary LIDAR data so as to identify a subject one of the scan zones that contains an object. The device detection system includes an aerial surveillance system configured to transmit one or more system output signals such that the one or more system output signals transmitted from the aerial surveillance system define an identification region within the detection space. The aerial surveillance system includes one or more actuators configured to move the aerial surveillance system so as to steer the identification region within the detection space. The aerial surveillance system includes a steering controller configured such that in response to the identification of the subject scan zone the one or more actuators are operated so as to move the aerial surveillance system such that the identification region overlaps the subject scan zone.

A method of operating a device detection system includes causing a LIDAR system to concurrently output multiple system output signals and scan the system output signals across a detection space. The method also includes calculating LIDAR data for multiple different scan zones within the detection space. The LIDAR data for a scan zone indicates a radial velocity between an object in the scan zone and the one or more LIDAR systems. The method also includes processing the preliminary LIDAR data so as to identify subject one of the scan zones that contains an object. The method further includes transmitting one or more system output signals such that the one or more system output signals define an identification region within the detection space. The method also includes responding to the identification of the subject scan zone by operating one or more actuators configured to move the aerial surveillance system such that the movement of the aerial surveillance system causes the identification region to overlap the subject scan zone.

A device detection system includes a preliminary LIDAR system configured to output one or more system output signals and scan the one or more system output signals across a detection space. In some instances, the preliminary LIDAR system is configured to concurrently output multiple system output signals and scan the system output signals across the detection space. The preliminary LIDAR system calculates preliminary LIDAR data for multiple different scan zones within the detection space. The preliminary LIDAR data for a scan zone indicates the radial velocity between an object in the scan zone and the one or more LIDAR systems. The preliminary LIDAR system processes the preliminary LIDAR data so as to identify a subject one of the scan zones that contains the object. The device detection system also includes a secondary LIDAR system configured to transmit one or more system output signals and to scan the one or more system output signals across the subject scan zone. The secondary LIDAR system calculates LIDAR data for multiple data regions. Each of the data regions at least partially overlaps the subject scan zone. The LIDAR data for each data region indicates the radial velocity and/or the distance between the object in the data region and the secondary LIDAR system.

A method of operating a device detection system includes causing a preliminary LIDAR system to concurrently output multiple system output signals and scan the system output signals across a detection space. The method also includes calculating preliminary LIDAR data for multiple different scan zones within the detection space. The preliminary LIDAR data for a scan zone indicates the radial velocity between an object in the scan zone and the preliminary LIDAR system. The method also includes processing the preliminary LIDAR data so as to identify a subject one of the scan zones that contains the object. The method also includes causing a secondary LIDAR system to transmit one or more system output signals and to scan the one or more system output signals across the subject scan zone. The method further includes calculating LIDAR data for multiple data regions. Each of the data regions at least partially overlaps the scan zone that the preliminary LIDAR system identified as containing the object. The LIDAR data for a data region indicates the radial velocity and/or the distance between the object in the data region and the secondary LIDAR system.

### BRIEF DESCRIPTION OF THE FIGURES

FIG. 1A is a schematic of an aerial device detection system having a preliminary LIDAR system in communication with a secondary LIDAR system.

FIG. 1B illustrates a projection of system output signals transmitted from the preliminary LIDAR system onto a plane.

FIG. 1C illustrates a projection of system output signals transmitted from the secondary LIDAR system onto a plane.

FIG. 2A is a topview of a schematic of a LIDAR chip that outputs a LIDAR output signal and receives a LIDAR input signal on a common waveguide.

FIG. 2B is a topview of a schematic of a LIDAR system that includes or consists of a LIDAR chip that outputs a LIDAR output signal and receives a LIDAR input signal on different waveguides.

FIG. 2C is a topview of a schematic of another embodiment of a LIDAR system that that includes or consists of a LIDAR chip that outputs a LIDAR output signal and receives multiple LIDAR input signals on different waveguides.

FIG. 3 is a topview of an example of a LIDAR adapter that is suitable for use with the LIDAR chip of FIG. 2B.

FIG. 4 is a topview of an example of a LIDAR adapter that is suitable for use with the LIDAR chip of FIG. 2C.

FIG. 5A is a topview of an example of a LIDAR assembly that includes the LIDAR chip of FIG. 2B and the LIDAR adapter of FIG. 3 on a common support.

FIG. 5B is a topview of an example of a LIDAR assembly that includes the LIDAR chip of FIG. 2C and the LIDAR adapter of FIG. 4 on a common support.

FIG. 5C illustrates the LIDAR assembly of FIG. 5A modified such that the optical pathways to and/or from a component on a LIDAR adapter include an optical fiber.

FIG. 6A illustrates a LIDAR system that includes a LIAR core on a support.

FIG. 6B illustrates a LIDAR system that includes multiple different cores on a common support.

FIG. 7 is a cross section of signal shaper configured to cause divergence of a core output signal.

FIG. 8A illustrates an example of a signal processor suitable for use with the LIDAR systems.

FIG. 8B provides a schematic of electronics that are suitable for use with a signal processor constructed according to FIG. 8A.

FIG. 8C is a graph of frequency versus time for a system output signal used to generate LIDAR data.

FIG. 8D is a graph of frequency versus time for a system output signal used to generate preliminary LIDAR data.

FIG. 8E is a schematic of a preliminary LS controller or a secondary LS controller having a LIDAR data processor 272 receiving LIDAR data results from different signal processors in the same core.

FIG. 8F is a schematic of a preliminary LS controller or a secondary LS controller having a LIDAR data processor 272 receiving LIDAR data results from signal processors in different cores.

FIG. 9 is a process flow for a method of operating a device detection system.

FIG. 10 is a cross section of a portion of a silicon-on-insulator wafer that includes a waveguide.

### DESCRIPTION

An aerial device detection system includes one or more preliminary LIDAR systems in communication with an aerial surveillance system. The one or more preliminary LIDAR systems concurrently output multiple system output signals. The one or more preliminary LIDAR systems scan the system output signals across the detection space and are configured to calculate preliminary LIDAR data for multiple different scan zones within the detection space. The preliminary LIDAR data for a scan zone can indicate a radial velocity between an object in the scan zone and the one or more LIDAR systems. The one or more preliminary LIDAR systems process the preliminary LIDAR data so as to identify a scan zone that may contain an object such as Unmanned Aerial Vehicle (UAVs).

The aerial surveillance system transmits one or more system output signals such that the one or more system output signals define an identification region within the detection space. The location of the identification region within the detection space can be steered such that the identification region overlaps the scan zone identified as containing the object. As a result, the aerial surveillance system can scan the scan zone that the preliminary LIDAR system identified as containing the object.

In one example, the aerial surveillance system is a secondary LIDAR system configured to transmit one or more system output signals that are scanned across the scan zone that the preliminary LIDAR system identified as containing the object. The secondary LIDAR system scans the system output signals across the scan zone that the one or more preliminary LIDAR systems identified as containing the object. Additionally, the secondary LIDAR system calculates LIDAR data for multiple data regions that each at least partially overlaps the scan zone. The LIDAR data for a data region indicates the radial velocity and/or the distance between the object in the identified data region and the secondary LIDAR system. The secondary LIDAR system processes the LIDAR data for the identified scan zone so as to identify whether the object is an Unmanned Aerial Vehicle (UAVs).

Increasing the number of system output signals output from prior LIDAR systems can increase the area being scanned by the LIDAR system. However, the number of system output signals that are needed to be effective at facilities such as airports makes the LIDAR system impractical and/or too expensive for use at these facilities. The disclosed aerial device detection system can detect objects within a detection space. The aerial surveillance system can have a higher resolution within the detection space than the resolution of the primary LIDAR system within the detection space. As a result, the primary LIDAR system is used to identify the location of the object within the detection space and the aerial surveillance system is used to determine the identity of the object at that location. Since the primary LIDAR system does not determine the identity of the object, the system output signals transmitted from the primary LIDAR system can have a larger spatial diameter on an object than the one or more system output signals transmitted from the aerial surveillance system. For instance, the system output signals transmitted from the primary LIDAR system can have a diameter greater than or equal to 10 m at 1 km from the primary LIDAR system. The increased width of the system output signals transmitted from the primary LIDAR system reduces the number of system output signals that need to be transmitted from the primary LIDAR system in order to scan the detection space. The reduced number of system output signals reduces the costs and complexity of the primary LIDAR system.

LIDAR can detect the presence of objects on the ground when there are objects present that would normally obscure the object to technologies such as radar. As a result, the initial detection of the object is done with technology that is suitable for use with low airborne devices when ground clutter is present. Additionally, LIDAR has low detectable emissions. Because UAVs are often set up to detect radar signals, these devices are frequently aware that they are being surveyed. Since it is not currently easy to detect optical emissions, LIDAR systems can often avoid detection by UAVs and other devices.

The preliminary LIDAR data generated by the preliminary LIDAR system can include the radial velocity between an object in a data region and the preliminary LIDAR system but exclude the distance between an object in a data region and the preliminary LIDAR system. Since the distance between an object and the preliminary LIDAR system is not calculated, the analog-to-digital converters used in the preliminary LIDAR system can have a lower sampling rate. Additionally, the bandwidth of other components in the preliminary LIDAR system, such as Transimpedance Amplifiers (TIAs), can be reduced. The reduction in sampling rate and bandwidth reduces the costs of the preliminary LIDAR system. Accordingly, the aerial device detection system can be simplified and have reasonable costs while retaining the ability to identify objects within large volume detection spaces such airports.

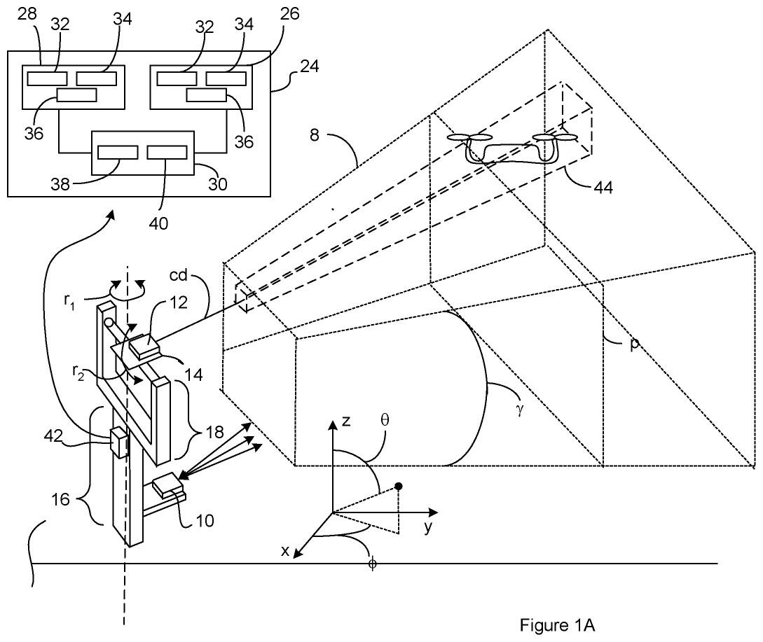

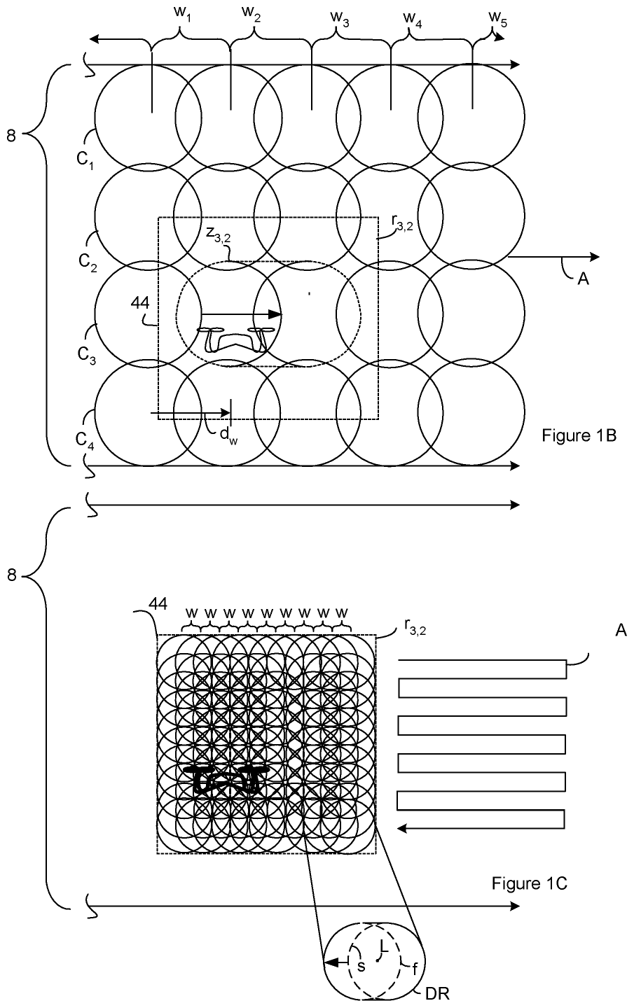

FIG. 1A is a schematic of an aerial device detection system configured to detect, identify, and/or response to aerial objects within a detection space 8. The aerial device detection system includes a preliminary LIDAR system 10 configured to detect the presence of an object within its field of view. The detected object may be an aerial device but could also be something other than an aerial device. An example of an aerial device is an Unmanned Aerial Vehicle (UAV) such as a drone. Other examples of aerial devices include, but are not limited to, man-made devices such as balloons including foil covered polyester resin balloons, planes, helicopters, model planes, model helicopters, and toys such as kites. Examples of objects that are not aerial devices include, but are not limited to, natural devices such as bird and other flying animals, snow, rain, leaves, windblown objects such as trash and other windblown objects.

The aerial device detection system includes an aerial surveillance system configured to determine whether an object detected by the preliminary LIDAR system 10 is an aerial device or an object that is not an aerial device. Examples of suitable aerial surveillance systems for use with the aerial device detection system include, but are not limited to, radar, IR detection cameras and thermals detection cameras. For the purposes of FIG. 1A, a secondary LIDAR system 12 serves as the aerial device detection system.

All or a portion of the secondary LIDAR system 12 can be mounted on a stage 14 that can be moved by an actuator 16. The actuator 16 can be configured to move the secondary LIDAR system 12 so as to direct system output signals transmitted by the secondary LIDAR system 12 to different regions of the detection space 8. For instance, an actuator can be configured to rotate the secondary LIDAR system 12 around one or more axis as illustrated by the arrows labeled r₁ and r₂ in FIG. 1A. Suitable actuators include, but are not limited to, pan-tilt stages and other pan-tilt actuators such as pan/tilt camera actuators.

In some instances, all or a portion of the preliminary LIDAR system 10 is stationary relative to the earth. For instance, the preliminary LIDAR system 10 can include one or more beam scanners configured to steer the direction of one or more system output signals transmitted from the preliminary LIDAR system 10. In some instances, the one or more beam scanners move relative to the ground while all or a portion of the remaining components of the preliminary LIDAR system 10 are stationary relative to the ground. For instance, the one or more beam scanners can include a mirror that moves relative to the ground.

The illustrated aerial device detection system includes a mount 18 that holds the one or more actuators 16. The one or more actuators 16 can move relative to the mount 18. The mount 18 can be immobilized relative to the ground. In some instances, the preliminary LIDAR system 10 is coupled to the mount 18. For instance, the preliminary LIDAR system 10 can be attached to the mount 18 and/or positioned on the mount 18.

The preliminary LIDAR system 10 can be configured to transmit multiple system output signals. The preliminary LIDAR system 10 can scan the system output signals such that the perimeter of the detection space 8 is defined by the system output signals. Although the aerial device detection system is illustrated as having a single preliminary LIDAR system 10, multiple preliminary LIDAR systems 10 can be used to increase the size of the detection space 8 in either the horizontal and/or vertical directions. In some instances, the detection space 8 has a divergence angle labeled y in a range of 10, 20, or 30 to 40, 50, or 60 degrees. Additionally, or alternately, the aerial device detection system can be arranged such that the bottom of the detection space 8 is parallel or substantially parallel to the ground. As a result, the aerial device detection system can detect objects close to the horizon.

The secondary LIDAR system 10 is configured to transmit one or more system output signals. In some instances, the secondary LIDAR system 12 is configured to transmit one system output signal. The secondary LIDAR system 10 can scan the one or more system output signals so as to define an identification region 44 within the detection space 8. The identification region can be a sub-section of the detection space 8. The movement of the secondary LIDAR system 10 by the one or more actuators can steer the location of the identification region 44 within the detection space 8. The volume of the identification region 44 can occupy less than 0.01%, 0.1%, or 1% of the volume of the detection space 8. In some instances, the volume of the identification region 44 occupies more than 2%, 5%, or 10% of the volume of the detection space 8.

The direction of the system output signals transmitted from the preliminary LIDAR system 10 and the one or more system output signals transmitted from the secondary LIDAR system 10 can be defined by the angular components of a spherical coordinate system. For instance, the direction of the system output signals can be described by the azimuthal angle ø and an elevation angle θ arranged as shown in FIG. 1A.

The aerial device detection system includes electronics 24. The electronics include a preliminary LS controller 26, a secondary LS controller 28, and an ADDS controller 30. The preliminary LS controller 26 and the secondary LS controller 28 each includes a light source controller 32, a scanner controller 34, and one or more data processors 36. The preliminary LS controller 26 includes a steering controller 38 and a response controller 40. The steering controller 38 can be configured to operate the one or more actuators so as to provide the secondary LIDAR system with the desired orientation relative to the detection space 8. Although not illustrated, the preliminary LS controller 26, secondary LS controller 28, and/or the ADDS controller 30 can include one or more storage devices for storage of electronics data and/or signals. Suitable memory devices include, but are not limited to, volatile memory like SRAM, DRAM for immediate use or non-volatile memory like flash for longer term storage.

The aerial device detection system can optionally include an electronics housing 42. The electronics housing 42 can be coupled to the mount 18. For instance, the electronics housing 42 can be attached to the mount 18 and/or positioned in or on the mount 18. The electronics 24 can be incorporated into the aerial device detection system at any location or distributed throughout the aerial device detection system. For instance, the electronics 24 can be distributed between the electronics housing 42, the preliminary LIDAR system 10, and the secondary LIDAR system 12. For instance, the preliminary LS controller 26 can be positioned in a housing for the preliminary LIDAR system 10 or in the electronics housing 42. Alternately, the preliminary LS controller 26 can be distributed between the housing for the preliminary LIDAR system 10 and the electronics housing 42. The secondary LS controller 26 can be positioned in a housing for the secondary LIDAR system 10 or in the electronics housing 42. Alternately, the secondary LS controller 26 can be distributed between the housing for the secondary LIDAR system 10 and the electronics housing 42. In one example, the preliminary LS controller 26, the secondary LS controller 28, and the ADDS controller 30 are located in the electronics housing 42.

In some instances, it may be desirable for all or a portion of the electronics to be located remotely from the mount 18. For instance, it may be desirable for multiple different aerial device detection systems to be linked together. As a result, it may be desirable to receive data from multiple different aerial device detection systems at a remote location and/or to control the different aerial device detection systems from the remote location. As a result, all or a portion of the electronics 24 to be at a location that is remote from the mount 18. Communication between the portion of the electronics 24 located at or near a mount 18 can be done through technologies such as electrical cabling, fiber optic cabling, and wireless transmission and can be over the Internet.

FIG. 1B illustrates a projection of the system output signals transmitted from the preliminary LIDAR system 10 onto a plane. For instance, FIG. 1B can represent a projection of the system output signals transmitted from the preliminary LIDAR system 10 onto a plane labeled p in the detection space 8 of FIG. 1A. An image of an aerial device is also present in FIG. 1A. Different system output signals can be considered different channels and can be labeled Cᵢ where i is a channel index. Accordingly, a portion of the spots in FIG. 1A are labeled with the label assigned to the system output signal that is the source of the spot. The spots labeled C₁ through C₄ in FIG. 1A are concurrently incident on the plane. As is evident from FIG. 1B, the system output signals can be arranged vertically in a column although other configurations are possible. The preliminary LIDAR system 10 can concurrently scan the system output signals in the direction of the arrow labeled A in FIG. 1A. As a result, the column of spots proceeds to the right in the image. As shown in FIG. 1B, the row of spots can define the detection space 8. For instance, the row of spots can span the detection space 8. As a result, the scan of the system output signal across the detection space can provide a scan of the detection space 8.

In some instances, the preliminary LIDAR system 10 is configured such that the direction indicated by the arrow labeled A in FIG. 1B is parallel or substantially parallel to the horizon. Accordingly, the preliminary LIDAR system 10 can optionally be scanned horizontally or substantially horizontally. Additionally, the preliminary LIDAR system 10 can optionally be positioned such that system output signals transmitted from the preliminary LIDAR system 10 are close to the ground. Accordingly, the preliminary LIDAR system 10 can detect the presence of aerial devices close to the ground and/or approaching the detection space from a low trajectory.

In some instances, the preliminary LIDAR system 10 is configured to calculate preliminary LIDAR data that includes the radial velocity between the preliminary LIDAR system 10 and the aerial device but excludes the distance between the preliminary LIDAR system and the aerial device. Each of the spots in FIG. 1B can represent the position of the system output signal at the start of a measurement window. The system output signals can continue to the be scanned during each of the measurement windows. As a result, each of the spots can travel a distance between the opening of the measurement window and the close of the measurement window. For instance, during measurement window w₁, the centroid of the system output signal labeled C₄ can travel the distance labeled d_{w} in FIG. 1B. Accordingly, the distance that the system output signals move during each of the measurement windows can be represented by wⱼ where j represents a window index. As shown in FIG. 1B, the windows for the same spot can occur serially in time.

The measurement windows for different system output signals can be the same or different duration and/or start concurrently or at different points in time. In FIG. 1B, the measurement windows for different system output signals have the same duration and the measurement window for each of the system output signals starts concurrently with a measurement window for the other system output signals.

The portion of the detection space 8 scanned by a system output signal during a measurement window can be considered a scan zone. A scan zone can be represented by z_{i,j} where i represents the channel index and j represents the window index. For instance, the portion of the detection space 8 scanned by the system output signal C₃, during measurement window w₂ is labeled z_{3,2} in FIG. 1B.

For all or a portion of the scan zones, the preliminary LIDAR system 10 can calculate preliminary LIDAR data for the scan zone. The preliminary LIDAR data for a scan zone can indicate the radial velocity between an object in the scan zone and the preliminary LIDAR system. The radial velocity for a scan zone is calculated from the system output signal that illuminates the scan zone during the measurement window associated with scan zone. The preliminary LIDAR system 10 can process the preliminary LIDAR data for the scan zones so as to identify the presence of an object in one or more of the scan zones.

In response to the one or more preliminary LIDAR systems identifying the presence of an object in a scan zone, the secondary LIDAR system can scan that scan zone so as to identify the object. For instance, the identification region 44 can be steered within the detection space such that the identification region 44 overlaps with and/or encompasses a scan zone where an object has been identified. As an example, FIG. 1B has a scan zone labeled z_{3,2} where the aerial device is present. In response to the presence of the aerial device in scan zone z_{3,2}, the one or more actuators 16 change the orientation of the secondary LIDAR system such that the identification region 44 is steered to the location labeled r_{3,2} where the identification region 44 fully overlaps or encompasses scan zone z_{3,2}. An identification region 44 can be steered so as to at least partially overlap a scan zone where an object has been detected. The identification region 44 can be sized such that the identification region 44 fully encompasses a single scan zone at a location along the length of the identification region 44. In some instances, identification region 44 is larger than, and is sized such that the identification region 44 fully encompasses more than one or more than two and less than 5, 10, or 20 scan zones at a location along the length of the identification region 44.

The secondary LIDAR system 12 can have an orientation relative to the detection space 22. For instance, the line labeled cd in FIG. 1A can represent the longitudinal axis of the identification region 44. The longitudinal axis can be an imaginary line through the centroids of cross sections of the identification region 44 as the identification region 44 becomes further away from the secondary LIDAR system. The orientation of the longitudinal axis can be defined by the angular components of the spherical coordinate system shown in FIG. 1A. For instance, the direction of the longitudinal axis can be described by the azimuthal angle ϕ and elevation angle θ arranged as shown in FIG. 1A. The one or more actuators can be operated so as to move the secondary LIDAR system such that the longitudinal axis of the identification region 44 has a particular direction (ϕ, θ). Moving the secondary LIDAR system so as to provide the longitudinal axis of the identification region 44 with a particular direction provides the secondary LIDAR system 12 with the desired orientation relative to the detection space 22. Accordingly, the direction of the longitudinal axis can serve as the orientation of the secondary LIDAR system 12.

Each scan region can be associated with an orientation relative to the detection space 8. For instance, each of the scan zones can have a longitudinal axis similar to the longitudinal axis for the identification region 44. The direction of the longitudinal axis for each scan zone can be described by the azimuthal angle ϕ and elevation angle θ arranged as shown in FIG. 1A.

Each of the scan zones can be associated with a different location for the identification region 44 and accordingly a different orientation for the second LIDAR system. For instance, the direction or orientation of a scan region can serve as the direction of the longitudinal axis for the identification region 44 associated with the scan region. In these instances, the system can respond to the preliminary LIDAR system identifying the presence of an object in a subject one of the scan zones by moving the secondary LIDAR system such that the longitudinal axis for the identification region 44 has the same direction as the subject scan zone. For instance, the one or more data processors 36 in the preliminary LS controller 26 can provide the orientation of the subject scan zone to the steering controller 38 in the ADDS controller 30. In response, the steering controller 38 can operate the one or more actuators 16 so as to provide the secondary LIDAR system with the orientation of the subject scan zone.

The degree of overlap between identification region 44 and the associated scan zone can be increased by reducing the distance between the location where system output signals are transmitted from the preliminary LIDAR system and the location where system output signals are transmitted from the secondary LIDAR system. In some instances, the distance between the location where system output signals are transmitted from the preliminary LIDAR system and the location where system output signals are transmitted from the secondary LIDAR system is less than 1 m, 2 m, or 5 m.

In some instances, each of the scan zones is associated with a desired orientation for the second LIDAR system. The electronics 24, such as the preliminary LS controller or the ADDS controller 30 can include one or more storage devices that store the orientations for the second LIDAR system such that each of the orientations is associated with one of the scan zones. For instance, the preliminary LS controller can include one or more storage devices that store orientations for the second LIDAR system (ϕ_{i,j}, θ_{i,j}) associated with scan zone z_{i,j} where i represents the channel index and j represents the window index and the values of ϕ_{i,j}, θ_{i,j} provide the direction of the longitudinal axis for the secondary LIDAR system 12. The orientations can be selected such that when the second LIDAR system has the orientation the overlap between the resulting identification zone 44 and the associated scan zone is optimized and/or maximized. In response to the preliminary LS controller identifying one of the scan zones as a subject scan zone, the preliminary LS controller can provide the ADDS controller 30 with the orientations for the second LIDAR system associated with the identified subject scan zone. The ADDS controller 30 can respond to the preliminary LIDAR system providing the orientation for the second LIDAR system by moving the secondary LIDAR system to the orientation associated with the subject scan zone.

In some instances, each of the scan zones is associated with a desired orientation for the second LIDAR system. For instance, the ADDS controller 30 can include one or more storage devices that store the orientations for the second LIDAR system such that each of the orientations is associated with one of the scan zones. For instance, the ADDS controller 30 can include one or more storage devices that store orientations for the second LIDAR system (ϕ_{i,j}, θ_{i,j}) associated with scan zone z_{i,j} where i represents the channel index and j represents the window index and the values of ϕ_{i,j}, θ_{i,j} provide the direction of the longitudinal axis for the secondary LIDAR system 12. The orientations can be selected such that when the second LIDAR system has the orientation the overlap between the resulting identification zone 44 and the associated scan zone is optimized and/or maximized. As a result, the system can respond to the preliminary LIDAR system identifying the one of the scan zones as a subject scan zone by moving the secondary LIDAR system to the orientation associated with the subject scan zone.

In some instances, as the distance between the preliminary LIDAR system and the secondary LIDAR system becomes larger, complete overlap of the identification region 44 with the associated scan zone can become more difficult. Accordingly, in some instances, the volume of the identification region 44 overlaps the volume of the associated scan zone by more than 200%, 300%, or 400% and less than or equal to 100%. Further, the shape and/or dimensions of the identification region 44 may change as the identification region 44 is steered to different locations within the detection space 8.

Once the secondary LIDAR system has the desired orientation relative to the detection space 8, the secondary LIDAR system 12 can scan the one or more system output signals transmitted by the secondary LIDAR system 12 within the identification zone 44. As an example, FIG. 1C illustrates the portion of the detection space 8 shown in FIG. 1B. Additionally, FIG. 1C shows the aerial device of FIG. 1B in the same location within the detection space 8.

The secondary LIDAR system 12 can be configured to calculate LIDAR data that includes the radial velocity and/or the distance between the secondary LIDAR system and the aerial device. In some instances, the LIDAR data also includes one or more material indicators. The LIDAR can be generated from light included in the one or more system output signals transmitted from the secondary LIDAR system 12. The LIDAR data are each associated with a data region of the detection space 8. The region of the detection space that is illuminated by a system output signal used to generate LIDAR data serves as a data region that is associated with the LIDAR data. Accordingly, different LIDAR data results can be associated with different data regions.

For the purpose of illustration, the secondary LIDAR system that provides FIG. 1C can transmit a single system output signal. The time that a system output signal from the secondary LIDAR system illuminates a data region is a cycle. Accordingly, different LIDAR data results can be generated from different cycles. Each of the spots in FIG. 1C can represent the position of a system output signal on the plane labeled p in FIG. 1A at the start of a cycle. The system output signals can continue to the be scanned during each of the cycles. The pattern of spots in FIG. 1C can result from the system output signal being scanned in a pattern such that the pattern shown by the arrow labeled A in FIG. 1C. As is evident from FIG. 1C, the scan pattern for the system output signal defines the identification region 44 in that the spots span the perimeter of the identification region 44. Each of the spots can travel a distance between the start of a cycle and the end of a cycle. The distance that the system output signal moves during different cycles is labeled w in FIG. 1C. As shown in FIG. 1C, the cycles can occur serially in time.

The portion of the detection space illuminated by a system output signal during a cycle serves a data region. As an example, two of the spots that are adjacent to one another in the scan sequence are blown up in FIG. 1C. The blown-up spot labeled s represents the location of the system output signal at the start of a cycle and the blown up spot labeled f represents the location of the system output signal at the end of the cycle. The data region that results from blown up spots is labeled DR. Accordingly, the label DR can represent the interface between the data region that results from the blown up spots with the plane labeled p in FIG. 1A. Each of the data regions can have a longitudinal axis similar to the longitudinal axis for an identification region 44. The location where the longitudinal of the example data region labeled DR passes through the example data region labeled DR is labeled L in FIG. 1C.

The identification region labeled r_{3,2} in FIG. 1B is also shown in FIG. 1C. A comparison of FIG. 1C and FIG. 1B shows the number density of data regions within the identification region r_{3,2} exceeds the number density of scan zones within the identification region. The number density of data regions can be selected such that there are multiple data regions within and/or overlapping the scan zone identified as containing the object. For instance, the longitudinal axis of more than 1,000, 5,000, or 10,000 data regions pass through a scan zone and/or can be located within the scan zone. Accordingly, the secondary preliminary LIDAR system scans a scan zone identified as containing the object at a higher resolution than the resolution of the scan zones. As a result, LIDAR data generated from the secondary LIDAR system has a higher resolution than preliminary LIDAR data generated from the preliminary LIDAR system. In some instances, a number density of data regions within an identification region is more than 1,000, 5,000, or 10,000 times the number density of scan zones within the identification region.

Aerial devices, such as a drone, have an identifiable pattern for the radial velocity and distance between the aerial device and a LIDAR system such as a secondary LIDAR system or a preliminary LIDAR system. The LIDAR data from the secondary LIDAR system can be compared to the VD patterns of one or more aerial devices to determine whether the LIDAR data matches one or more of the VD patterns. For instance, an experimental VD pattern can be generated from the LIDAR data provided by the secondary LIDAR system. The experimental velocity pattern can be compared to stored VD patterns of one or more aerial devices to determine if a match is present. Additionally, or alternately, experimental VD patterns for an aerial device can be generated at various distances, orientations, speeds and radial velocities. The experimental VD patterns for the aerial device can be used to train a machine learning framework such a neural network or artificial intelligence. The trained machine learning framework can then identify whether an object matches an aerial device by applying the training to an experimental VD pattern for the object. This approach can be repeated for multiple different aerial devices and may not require storage of the experimental VD patterns used to train the machine learning framework.

The aerial device detection system can take one or more detection actions in response to a match between an experimental velocity pattern and a stored velocity pattern. For instance, an aerial device detection system can be located at an airport and can include one or more signal jammers. In response to a match between an experimental velocity pattern and the stored velocity pattern of a drone at an airport, the aerial device detection system can activate the one or more signal jammers so as to prevent the ability of the drone to send and/or receive communications. Accordingly, the aerial device detection system can neutralize threats from the drone.

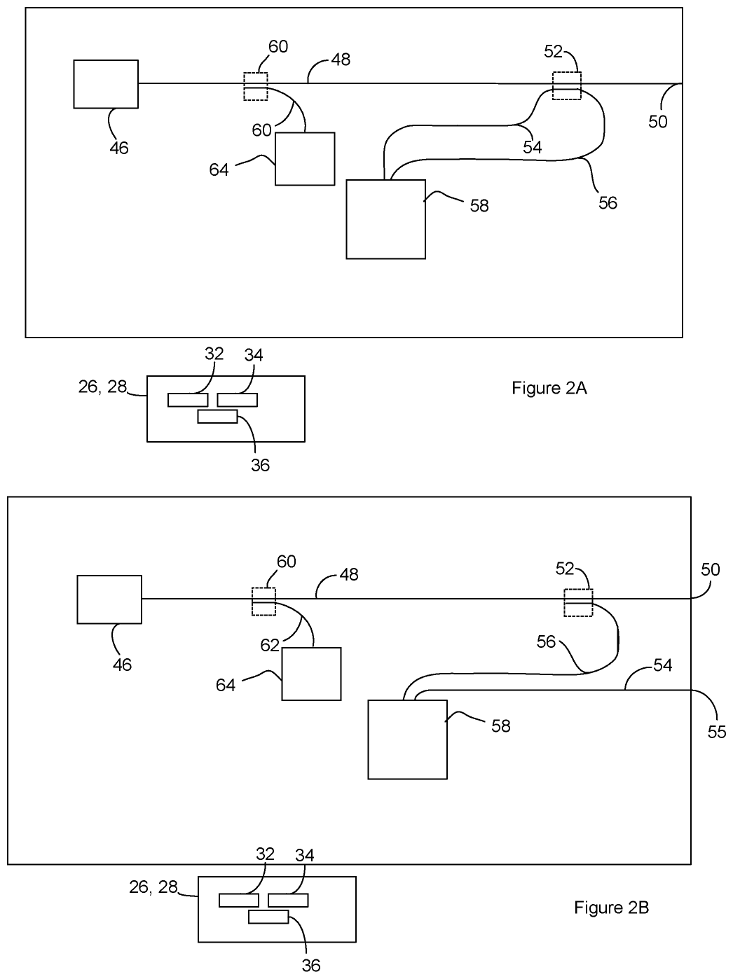

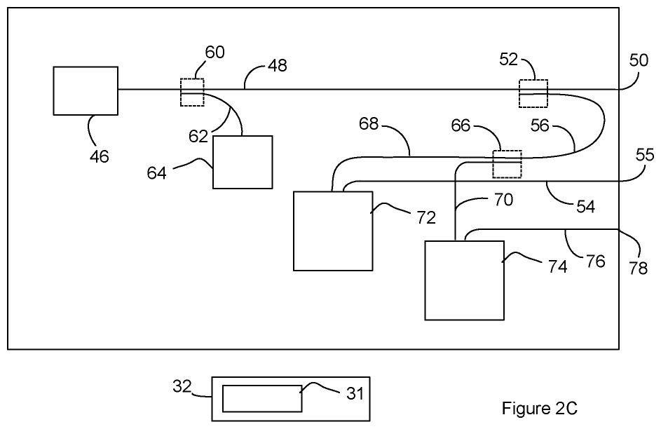

FIG. 2A is a topview of a schematic of a LIDAR chip. A preliminary LIDAR system and/or a preliminary LIDAR system can include the LIDAR chip of FIG. 2A in addition to other components. The LIDAR chip can include a Photonic Integrated Circuit (PIC) and can be a Photonic Integrated Circuit chip. The LIDAR chip includes a light source 46 that outputs a preliminary outgoing LIDAR signal. A suitable light source 46 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

The LIDAR chip includes a utility waveguide 48 that receives an outgoing LIDAR signal from a light source 46. The utility waveguide 48 terminates at a facet 50 and carries the outgoing LIDAR signal to the facet 50. The facet 50 can be positioned such that the outgoing LIDAR signal traveling through the facet 50 exits the LIDAR chip and serves as a LIDAR output signal. For instance, the facet 50 can be positioned at an edge of the chip so the outgoing LIDAR signal traveling through the facet 50 exits the chip and serves as the LIDAR output signal.

A LIDAR system, such as a preliminary LIDAR system or a secondary LIDAR system, that includes the LIDAR chip can transmit a system output signal that include light from the LIDAR output signal. The system output signal travels away from the LIDAR system through free space in the environment and/or atmosphere in which the LIDAR system is positioned. The system output signal may be reflected by one or more objects in the path of the system output signal. When the system output signal is reflected, at least a portion of the reflected light travels back toward the LIDAR system as a return signal. The LIDAR chip receives a LIDAR input signal that includes light from the return signal.

The LIDAR input signals can enter the utility waveguide 48 through the facet 50. The portion of the LIDAR input signal that enters the utility waveguide 48 serves as an incoming LIDAR signal. The utility waveguide 48 carries the incoming LIDAR signal to a splitter 52 that moves a portion of the outgoing LIDAR signal from the utility waveguide 48 onto a comparative waveguide 54 as a comparative signal. The comparative waveguide 54 carries the comparative signal to a signal processor 58 for further processing. Although FIG. 2A illustrates a directional coupler operating as the splitter 52, other signal tapping components can be used as the splitter 16. Suitable splitters 16 include, but are not limited to, directional couplers, optical couplers, Y-junctions, tapered couplers, and Multi-Mode Interference (MMI) devices.

The utility waveguide 48 also carries the outgoing LIDAR signal to the splitter 52. The splitter 52 moves a portion of the outgoing LIDAR signal from the utility waveguide 48 onto a reference waveguide 56 as a reference signal. The reference waveguide 56 carries the reference signal to the signal processor 58 for further processing.

The percentage of light transferred from the utility waveguide 48 by the splitter 52 can be fixed or substantially fixed. For instance, the splitter 52 can be configured such that the power of the reference signal transferred to the reference waveguide 56 is an outgoing percentage of the power of the outgoing LIDAR signal or such that the power of the comparative signal transferred to the comparative waveguide 54 is an incoming percentage of the power of the incoming LIDAR signal. In many splitters 16, such as directional couplers and multimode interferometers (MMIs), the outgoing percentage is equal or substantially equal to the incoming percentage. In some instances, the outgoing percentage is greater than 30%, 40%, or 49% and/or less than 51%, 60%, or 70% and/or the incoming percentage is greater than 30%, 40%, or 49% and/or less than 51%, 60%, or 70%. A splitter 52 such as a multimode interferometer (MMI) generally provides an outgoing percentage and an incoming percentage of 50% or about 50%. However, multimode interferometers (MMIs) can be easier to fabricate in platforms such as silicon-on-insulator platforms than some alternatives. In one example, the splitter 52 is a multimode interferometer (MMI) and the outgoing percentage and the incoming percentage are 50% or substantially 50%. As will be described in more detail below, the signal processor 58 combines the comparative signal with the reference signal to form a composite signal. The composite signal can be processed so as to extract LIDAR data and/or preliminary LIDAR data.

The LIDAR chip can include a control branch for controlling operation of the light source 46. The control branch includes a splitter 60 that moves a portion of the outgoing LIDAR signal from the utility waveguide 48 onto a control waveguide 62. The coupled portion of the outgoing LIDAR signal serves as a tapped signal. Although FIG. 2A illustrates a directional coupler operating as the splitter 60, other signal tapping components can be used as the splitter 60. Suitable splitters 60 include, but are not limited to, directional couplers, optical couplers, Y-junctions, tapered couplers, and Multi-Mode Interference (MMI) devices.

The control waveguide 62 carries the tapped signal to control components 64. The control components can be in electrical communication with, or part of, a light source controller 32 included in a preliminary LS controller 26 or included in a secondary LS controller 28. All or a portion of the control components 64 can be included in a preliminary LS controller 26 when the LIDAR chip is included in a preliminary LIDAR system or in a secondary LS controller 28 when the LIDAR chip is included in a secondary LIDAR system. During operation, the light source controller 32 can employ output from the control components 64 in a control loop configured to control a process variable of one, two, or three loop controlled light signals selected from the group consisting of the tapped signal, the system output signal, and the outgoing LIDAR signal. Examples of the suitable process variables include the frequency of the loop controlled light signal and/or the phase of the loop controlled light signal.

The LIDAR chip can be modified so the incoming LIDAR signal and the outgoing LIDAR signal can be carried on different waveguides. For instance, FIG. 2B is a topview of the LIDAR chip of FIG. 2A modified such that the incoming LIDAR signal and the outgoing LIDAR signal are carried on different waveguides. The outgoing LIDAR signal exits the LIDAR chip through the facet 50 and serves as the LIDAR output signal. When light from the LIDAR output signal is reflected by an object external to the LIDAR system, at least a portion of the reflected light returns to the LIDAR chip as a first LIDAR input signal. The first LIDAR input signals enters the comparative waveguide 54 through facet 55 and serves as the comparative signal. The comparative waveguide 54 carries the comparative signal to a signal processor 58 for further processing. As described in the context of FIG. 2A, the reference waveguide 56 carries the reference signal to the signal processor 58 for further processing. As will be described in more detail below, the signal processor 58 combines the comparative signal with the reference signal to form a composite signal.

The LIDAR chips can be modified to receive multiple LIDAR input signals. For instance, FIG. 2C illustrates the LIDAR chip of FIG. 2B modified to receive two LIDAR input signals. A splitter 66 is configured to place a portion of the reference signal carried on the reference waveguide 56 on a first reference waveguide 68 and another portion of the reference signal on a second reference waveguide 70. Accordingly, the first reference waveguide 68 carries a first reference signal and the second reference waveguide 70 carries a second reference signal. The first reference waveguide 68 carries the first reference signal to a first signal processor 72 and the second reference waveguide 70 carries the second reference signal to a second signal processor 74. Examples of suitable splitters 40 include, but are not limited to, Y-junctions, optical couplers, and multi-mode interference couplers (MMIs).

The outgoing LIDAR signal exits the LIDAR chip through the facet 50 and serves as the LIDAR output signal. When light from the LIDAR output signal is reflected by one or more objects located external to the LIDAR system, at least a portion of the reflected light returns to the LIDAR chip as a first LIDAR input signal. The first LIDAR input signals enters the comparative waveguide 54 through the facet 55 and serves as a first comparative signal. The comparative waveguide 54 carries the first comparative signal to a first signal processor 72 for further processing.

Additionally, when light from the LIDAR output signal is reflected by one or more objects located external to the LIDAR system, at least a portion of the reflected signal returns to the LIDAR chip as a second LIDAR input signal. The second LIDAR input signals enters a second comparative waveguide 76 through a facet 78 and serves as a second comparative signal carried by the second comparative waveguide 76. The second comparative waveguide 76 carries the second comparative signal to a second signal processor 74 for further processing.

Although the light source 46 is shown as being positioned on the LIDAR chip, the light source 46 can be located off the LIDAR chip. For instance, the utility waveguide 48 can terminate at a second facet through which the outgoing LIDAR signal can enter the utility waveguide 48 from a light source 46 located off the LIDAR chip.

In some instances, a LIDAR system includes a LIDAR adapter in addition to a LIDAR chip. For instance, a LIDAR system can include a LIDAR adapter in addition to a LIDAR chip constructed according to FIG. 2B or FIG. 2C. The LIDAR adapter can be optically positioned such that the adapter receives the LIDAR output signal from the LIDAR chip and the LIDAR chip receives the first LIDAR input signal from the adapter. Additionally, the LIDAR adapter can be configured to operate on the first LIDAR input signal and the LIDAR output signal such that the first LIDAR input signal and the LIDAR output signal travel on different optical pathways between the LIDAR adapter and the LIDAR chip but on the same optical pathway between the LIDAR adapter and a reflecting object in the field of view.

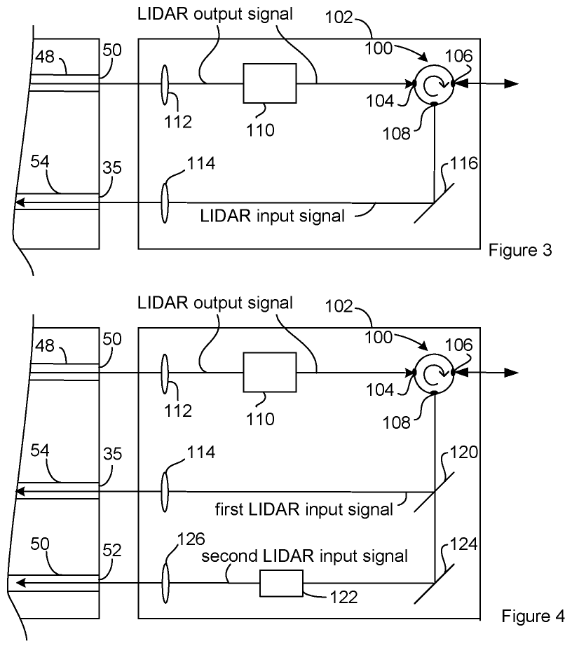

An example of a LIDAR adapter that is suitable for use with the LIDAR chip of FIG. 2B is illustrated in FIG. 3. The LIDAR adapter includes multiple components positioned on a base. For instance, the LIDAR adapter includes a circulator 100 positioned on a base 102. The illustrated optical circulator 100 includes three ports and is configured such that light entering one port exits from the next port. For instance, the illustrated optical circulator includes a first port 104, a second port 106, and a third port 108. The LIDAR output signal enters the first port 104 from the utility waveguide 48 of the LIDAR chip and exits from the second port 106.

The LIDAR adapter can be configured such that the output of the LIDAR output signal from the second port 106 can also serve as the output of the LIDAR output signal from the LIDAR adapter and accordingly from the LIDAR system. As a result, the LIDAR output signal can be output from the LIDAR adapter such that the LIDAR output signal is traveling away from the LIDAR system. Accordingly, in some instances, the portion of the LIDAR output signal that has exited from the LIDAR adapter can also be considered the system output signal. As an example, when the exit of the LIDAR output signal from the LIDAR adapter is also an exit of the LIDAR output signal from the LIDAR system, the LIDAR output signal can also be considered a system output signal.

The LIDAR output signal output from the LIDAR adapter includes, consists of, or consists essentially of light from the LIDAR output signal received from the LIDAR chip. Accordingly, the LIDAR output signal output from the LIDAR adapter may be the same or substantially the same as the LIDAR output signal received from the LIDAR chip. However, there may be differences between the LIDAR output signal output from the LIDAR adapter and the LIDAR output signal received from the LIDAR chip. For instance, the LIDAR output signal can experience optical loss as it travels through the LIDAR adapter and/or the LIDAR adapter can optionally include an amplifier configured to amplify the LIDAR output signal as it travels through the LIDAR adapter.

When one or more objects external to the LIDAR system reflect light from the LIDAR output signal, at least a portion of the reflected light can travel back to the circulator 100 as a system return signal. The system return signal enters the circulator 100 through the second port 106. FIG. 3 illustrates the LIDAR output signal and the system return signal traveling between the LIDAR adapter and an object external to the LIDAR system, such as an aerial device, along the same optical path.

The system return signal exits the circulator 100 through the third port 108 and is directed to the comparative waveguide 54 on the LIDAR chip. Accordingly, all or a portion of the system return signal can serve as the first LIDAR input signal and the first LIDAR input signal includes or consists of light from the system return signal. Accordingly, the LIDAR output signal and the first LIDAR input signal travel between the LIDAR adapter and the LIDAR chip along different optical paths.

As is evident from FIG. 3, the LIDAR adapter can include optical components in addition to the circulator 100. For instance, the LIDAR adapter can include components for directing and controlling the optical path of the LIDAR output signal and the system return signal. As an example, the adapter of FIG. 3 includes an optional amplifier 110 positioned so as to receive and amplify the LIDAR output signal before the LIDAR output signal enters the circulator 100. The amplifier 110 can be operated by a light source controller 32 allowing the light source controller 32 to control the power of the LIDAR output signal. Suitable amplifiers include, but are not limited to, Semiconductor Optical Amplifiers (SOAs), optical fiber based amplifiers, or optical waveguide based amplifiers. In some instances, the amplifier 110 is an Erbium-doped fiber amplifier (EDFAs) or Erbium-doped waveguide amplifier (EDWAs). Erbium-doped fiber amplifiers (EDFAs) or Erbium-doped waveguide amplifier (EDWAs) can efficiently provide the system output signals with sufficient power levels at distances greater than or equal to 1 km from the preliminary LIDAR system or the secondary LIDAR system. Erbium-doped fiber amplifiers (EDFAs) can provide the system output signals with a power level greater than or equal to 1 W or 3 W at distances greater than or equal to 1 km from the preliminary LIDAR system or the secondary LIDAR system.

FIG. 3 also illustrates the LIDAR adapter including an optional first lens 112 and an optional second lens 114. The first lens 112 can be configured to couple the LIDAR output signal to a desired location. In some instances, the first lens 112 is configured to focus or collimate the LIDAR output signal at a desired location. In one example, the first lens 112 is configured to couple the LIDAR output signal on the first port 104 when the LIDAR adapter does not include an amplifier 110. As another example, when the LIDAR adapter includes an amplifier 110, the first lens 112 can be configured to couple the LIDAR output signal on the entry port to the amplifier 110. The second lens 114 can be configured to couple the LIDAR output signal at a desired location. In some instances, the second lens 114 is configured to focus or collimate the LIDAR output signal at a desired location. For instance, the second lens 114 can be configured to couple the LIDAR output signal the on the facet 55 of the comparative waveguide 54.

The LIDAR adapter can also include one or more direction changing components such as mirrors. FIG. 3 illustrates the LIDAR adapter including a mirror as a direction-changing component 116 that redirects the system return signal from the circulator 100 to the facet 20 of the comparative waveguide 54.

The LIDAR chips include one or more waveguides that constrains the optical path of one or more light signals. While the LIDAR adapter can include waveguides, the optical path that the system return signal and the LIDAR output signal travel between components on the LIDAR adapter and/or between the LIDAR chip and a component on the LIDAR adapter can be free space. For instance, the system return signal and/or the LIDAR output signal can travel through the environment and/or atmosphere in which the LIDAR chip, the LIDAR adapter, and/or the base 102 is positioned when traveling between the different components on the LIDAR adapter and/or between a component on the LIDAR adapter and the LIDAR chip. As a result, optical components such as lenses and direction changing components can be employed to control the characteristics of the optical path traveled by the system return signal and the LIDAR output signal on, to, and from the LIDAR adapter.

Suitable bases 102 for the LIDAR adapter include, but are not limited to, substrates, platforms, and plates. Suitable substrates include, but are not limited to, glass, silicon, and ceramics. The components can be discrete components that are attached to the substrate. Suitable techniques for attaching discrete components to the base 102 include, but are not limited to, epoxy, solder, and mechanical clamping. In one example, one or more of the components are integrated components and the remaining components are discrete components. In another example, the LIDAR adapter includes one or more integrated amplifiers, and the remaining components are discrete components.

A LIDAR system can be configured to compensate for polarization. Light from a laser source is typically linearly polarized and hence the LIDAR output signal is also typically linearly polarized. Reflection from an object may change the angle of polarization of the returned light. Accordingly, the system return signal can include light of different linear polarization states. For instance, a first portion of a system return signal can include light of a first linear polarization state and a second portion of a system return signal can include light of a second linear polarization state. The intensity of the resulting composite signals is proportional to the square of the cosine of the angle between the comparative and reference signal polarization fields. If the angle is 90 degrees, the LIDAR data can be lost in the resulting composite signal. However, the LIDAR system can be modified to compensate for changes in polarization state of the LIDAR output signal.

FIG. 4 illustrates the LIDAR adapter of FIG. 3 modified such that the LIDAR adapter is suitable for use with the LIDAR chip of FIG. 2C. The LIDAR adapter includes a beamsplitter 120 that receives the system return signal from the circulator 100. The beamsplitter 120 splits the system return signal into a first portion of the system return signal and a second portion of the system return signal. Suitable beamsplitters include, but are not limited to, Wollaston prisms, and MEMS-based beamsplitters.

The first portion of the system return signal is directed to the comparative waveguide 54 on the LIDAR chip and serves as the first LIDAR input signal described in the context of FIG. 2C. The second portion of the system return signal is directed to a polarization rotator 122. The polarization rotator 122 outputs a second LIDAR input signal that is directed to the second input waveguide 76 on the LIDAR chip and serves as the second LIDAR input signal.

The beamsplitter 120 can be a polarizing beam splitter. One example of a polarizing beamsplitter is constructed such that the first portion of the system return signal has a first polarization state but does not have or does not substantially have a second polarization state and the second portion of the system return signal has a second polarization state but does not have or does not substantially have the first polarization state. The first polarization state and the second polarization state can be linear polarization states and the second polarization state is different from the first polarization state. For instance, the first polarization state can be TE and the second polarization state can be TM or the first polarization state can be TM and the second polarization state can be TE. In some instances, the laser source can be linearly polarized such that the LIDAR output signal has the first polarization state. Suitable beamsplitters include, but are not limited to, Wollaston prisms, and MEMs-based polarizing beamsplitters.

A polarization rotator can be configured to change the polarization state of the first portion of the system return signal and/or the second portion of the system return signal. For instance, the polarization rotator 122 shown in FIG. 4 can be configured to change the polarization state of the second portion of the system return signal from the second polarization state to the first polarization state. As a result, the second LIDAR input signal has the first polarization state but does not have or does not substantially have the second polarization state. Accordingly, the first LIDAR input signal and the second LIDAR input signal each have the same polarization state (the first polarization state in this example). Despite carrying light of the same polarization state, the first LIDAR input signal and the second LIDAR input signal are associated with different polarization states as a result of the use of the polarizing beamsplitter. For instance, the first LIDAR input signal carries the light reflected with the first polarization state and the second LIDAR input signal carries the light reflected with the second polarization state. As a result, the first LIDAR input signal is associated with the first polarization state and the second LIDAR input signal is associated with the second polarization state.

Since the first LIDAR input signal and the second LIDAR carry light of the same polarization state, the comparative signals that result from the first LIDAR input signal have the same polarization angle as the comparative signals that result from the second LIDAR input signal.

Suitable polarization rotators include, but are not limited to, rotation of polarization-maintaining fibers, Faraday rotators, half-wave plates, MEMs-based polarization rotators and integrated optical polarization rotators using asymmetric y-branches, Mach-Zehnder interferometers and multi-mode interference couplers.

Since the outgoing LIDAR signal is linearly polarized, the first reference signals can have the same linear polarization state as the second reference signals. Additionally, the components on the LIDAR adapter can be selected such that the first reference signals, the second reference signals, the comparative signals and the second comparative signals each have the same polarization state. In the example disclosed in the context of FIG. 4, the first comparative signals, the second comparative signals, the first reference signals, and the second reference signals can each have light of the first polarization state.

As a result of the above configuration, first composite signals generated by the first signal processor 72 and second composite signals generated by the second signal processor 74 each results from combining a reference signal and a comparative signal of the same polarization state and will accordingly provide the desired beating between the reference signal and the comparative signal. For instance, the composite signal results from combining a first reference signal and a first comparative signal of the first polarization state and excludes or substantially excludes light of the second polarization state or the composite signal results from combining a first reference signal and a first comparative signal of the second polarization state and excludes or substantially excludes light of the first polarization state. Similarly, the second composite signal includes a second reference signal and a second comparative signal of the same polarization state will accordingly provide the desired beating between the reference signal and the comparative signal. For instance, the second composite signal results from combining a second reference signal and a second comparative signal of the first polarization state and excludes or substantially excludes light of the second polarization state or the second composite signal results from combining a second reference signal and a second comparative signal of the second polarization state and excludes or substantially excludes light of the first polarization state.

Although FIG. 4 is described in the context of components being arranged such that the first comparative signals, the second comparative signals, the first reference signals, and the second reference signals each have the first polarization state, other configurations of the components in FIG. 4 can arranged such that the composite signals result from combining a reference signal and a comparative signal of the same linear polarization state and the second composite signal results from combining a reference signal and a comparative signal of the same linear polarization state. For instance, the beamsplitter 120 can be constructed such that the second portion of the system return signal has the first polarization state and the first portion of the system return signal has the second polarization state, the polarization rotator receives the first portion of the system return signal, and the outgoing LIDAR signal can have the second polarization state. In this example, the first LIDAR input signal and the second LIDAR input signal each has the second polarization state.

The above system configurations result in the first portion of the system return signal and the second portion of the system return signal being directed into different composite signals. As a result, since the first portion of the system return signal and the second portion of the system return signal are each associated with a different polarization state but electronics can process each of the composite signals, the LIDAR system compensates for changes in the polarization state of the LIDAR output signal in response to reflection of the LIDAR output signal.

The LIDAR adapter of FIG. 4 can have additional optical components including passive optical components. For instance, the LIDAR adapter can include an optional third lens 126. The third lens 126 can be configured to couple the second LIDAR output signal at a desired location. In some instances, the third lens 126 focuses or collimates the second LIDAR output signal at a desired location. For instance, the third lens 126 can be configured to focus or collimate the second LIDAR output signal on the facet 78 of the second comparative waveguide 76. The LIDAR adapter also includes one or more direction changing components 124 such as mirrors and prisms. FIG. 4 illustrates the LIDAR adapter including a mirror as a direction changing component 124 that redirects the second portion of the system return signal from the circulator 100 to the facet 78 of the second comparative waveguide 76 and/or to the third lens 126.

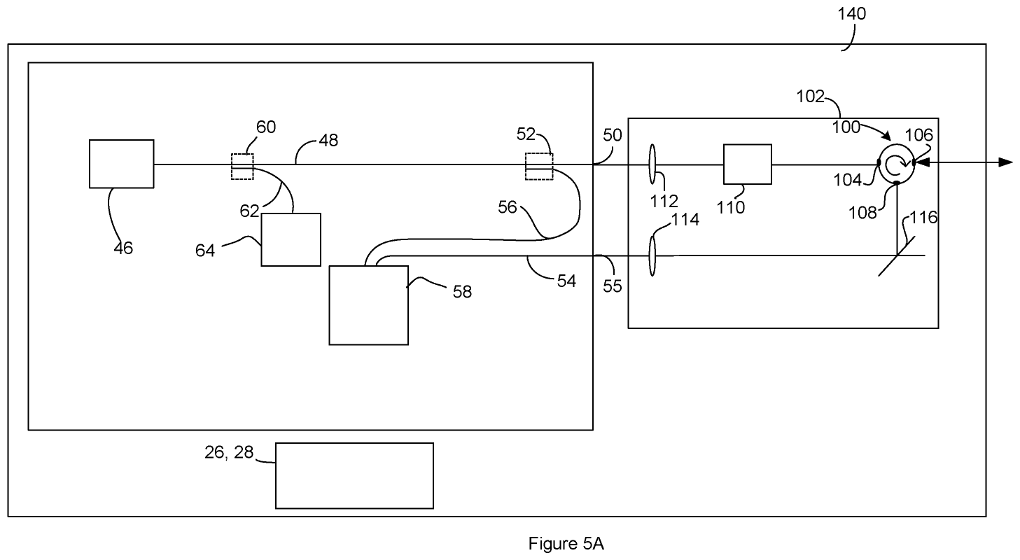

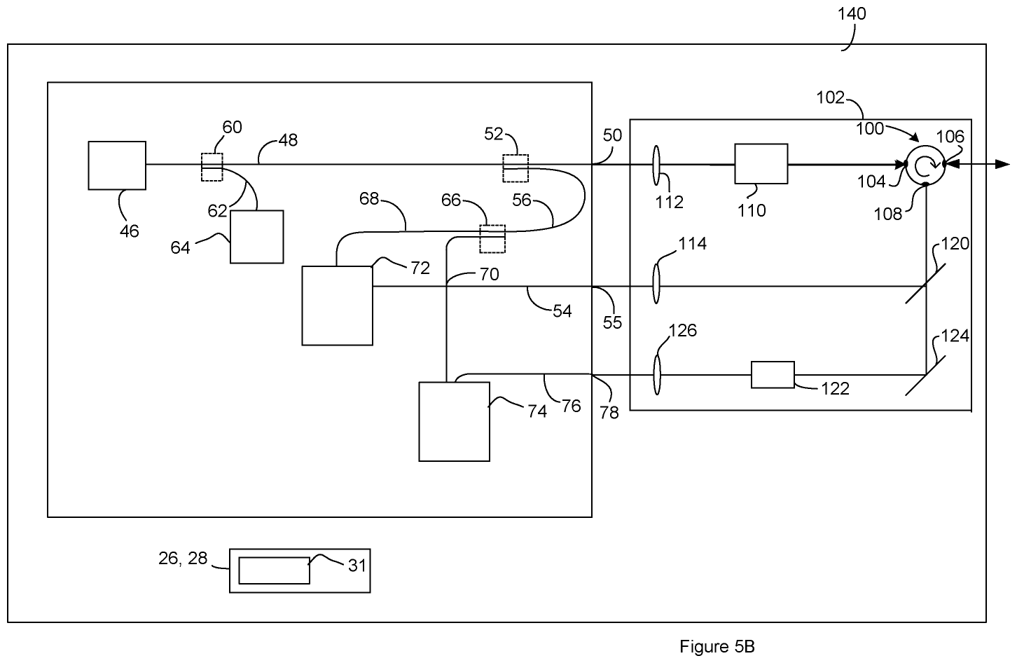

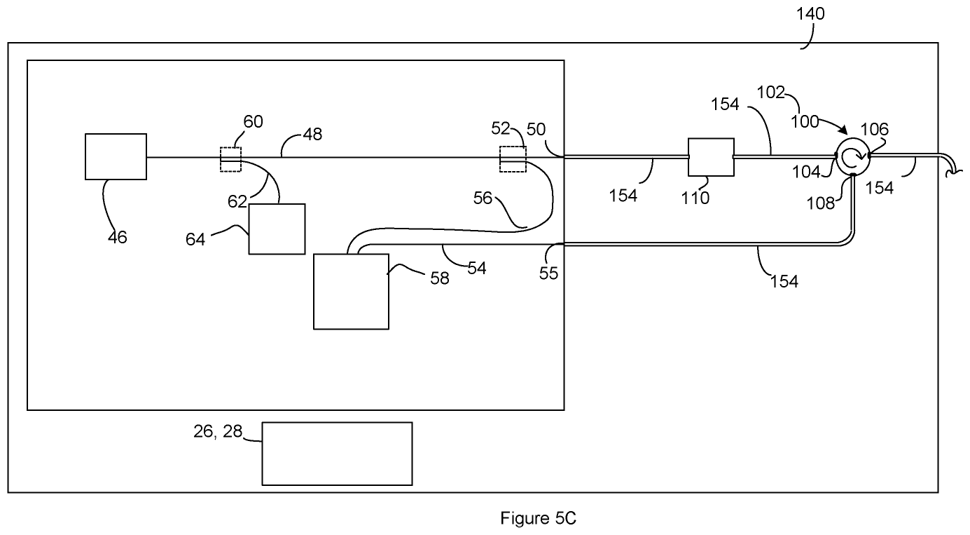

When a LIDAR adapter is used in combination with a LIDAR chip, the LIDAR chip, the LIDAR adapter and any associated electronics can be positioned on a common mount. Suitable common mounts include, but are not limited to, glass plates, metal plates, silicon plates and ceramic plates. As an example, FIG. 5A is a topview of a LIDAR assembly that includes the LIDAR chip 2B on a common support 140 with the LIDAR adapter of FIG. 3 and a preliminary LS controller 26 or a secondary LS controller 28. Although the preliminary LS controller 26 or the secondary LS controller 28 is illustrated as being located on the common support, all or a portion of the preliminary LS controller 26 or the secondary LS controller 28 can be located off the common support. When the light source 46 is located off the LIDAR chip, the light source can be located on the common support 140 or off of the common support 140. Suitable approaches for mounting a preliminary LS controller 26 or a secondary LS controller 28, a LIDAR chip, and/or the LIDAR adapter on the common support include, but are not limited to, epoxy, solder, and mechanical clamping.

As another example, FIG. 5B is a topview of a LIDAR assembly that includes the LIDAR chip of FIG. 2C on a common support 140 with the LIDAR adapter of FIG. 4 and a preliminary LS controller 26 or a secondary LS controller 28.

All or a portion of the optical pathways between a LIDAR chip and a component of a LIDAR adapter can include or consist of an optical fiber. All or a portion of the optical pathways between a component of a LIDAR adapter and a component external to the LIDAR adapter, such as a lens, signal shaper, or scanner, can include or consist of an optical fiber. All or a portion of the optical pathways between components of a LIDAR adapter can include or consist of an optical fiber. As an example FIG. 5C illustrates the LIDAR assembly of FIG. 5A, where the optical pathways between the LIDAR chip and the components of a LIDAR adapter include an optical fiber 154. Additionally, FIG. 5C illustrates an optical fiber 154 included in the optical pathways between components of the LIDAR adapter and also in an optical pathway between a components of the LIDAR adapter and a component external to the adapter.

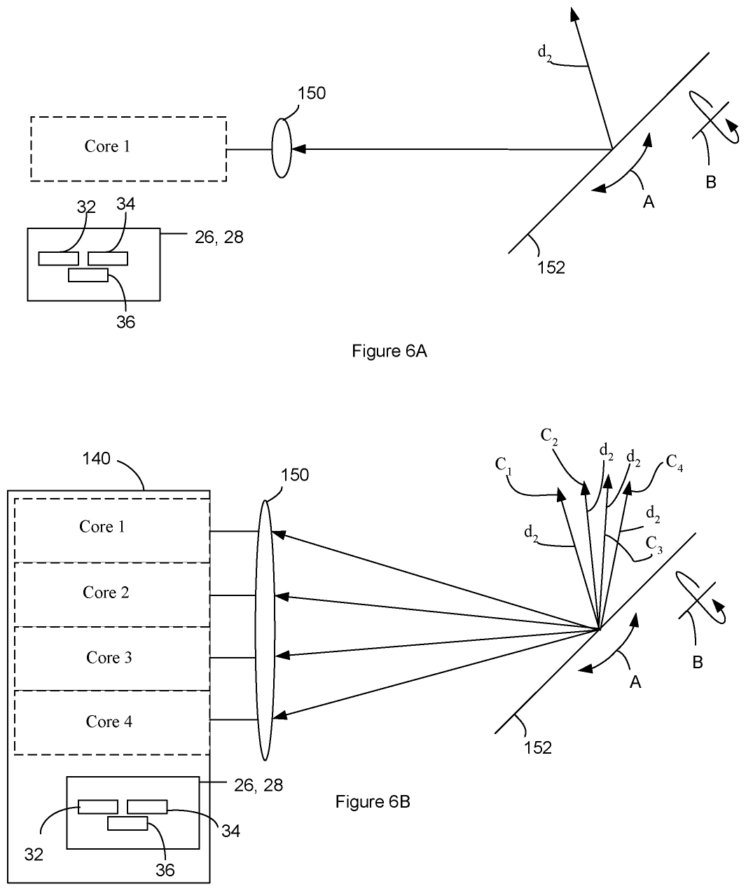

One or more components selected from a group consisting of the LIDAR chips, the combinations of LIDAR chip and LIDAR adapter, and the LIDAR assemblies can each serve as a LIDAR core in a LIDAR system. A LIDAR system can include one or more of the cores. FIG. 6A illustrates a LIDAR system that includes a single core. Each of the LIDAR cores can be constructed as disclosed in the context of FIG. 2A through FIG. 5B or can have an alternate construction. Each of the LIDAR cores outputs a core output signal. For instance, when a LIDAR chip serves as a core, the LIDAR output signal output from the LIDAR chip can serve as a core output signal. When a LIDAR chip in combination with a LIDAR adapter serves as a core the LIDAR output signal output from the LIDAR adapter can serve as a core output signal. When a LIDAR assembly serves as a core the LIDAR output signal output from the LIDAR adapter can serve as a core output signal.

The LIDAR system can include one or more signal shapers that receive the core output signal. FIG. 6A shows the core output signal is received by one signal shaper 150 that shapes the core output signal. Suitable signal shapers 150 include, but are not limited to, lenses such as convex lenses and mirrors such as concave mirrors. Accordingly, a signal shaper 150 can be configured to focus, expand, or collimate a core output signal.

The shaped core output signal output from the one or more signal shapers 150 is received by one or more scanners 152 that output the core output signal as a system output signal traveling away from the LIDAR system. The direction that the system output signal travels away from the LIDAR system is labeled d₂ in FIG. 6A. A scanner controller 34 can operate the one or more scanners 152 so as to steer each of the core output signal to different data regions in a field of view. As is evident from the arrows labeled A and B in FIG. 6A, the one or more scanners 152 can be configured such that the scanner controller 34 can steer the core output signals in one, two, or three dimensions. As a result, the one or more scanners 152 can function as a beam-steering mechanism that is operated by the scanner controller 34 so as to steer the system output signal within the field of view of the LIDAR system. Suitable scanners 152 include, but are not limited to, movable mirrors, MEMS mirrors, optical phased arrays (OPAs), optical gratings, and actuated optical gratings.

In some instances, the one or more signal shapers 150 and/or the one or more scanners 152 are configured to operate on the core output signal such that the system output signal is collimated or substantially collimated as it travels away from the LIDAR system. Additionally, or alternately, the LIDAR system can include one or more collimating optical components (not illustrated) that operate on the core output signal such that the system output signal is collimated or substantially collimated as it travels away from the LIDAR system. For instance, when the LIDAR system serves as a secondary LIDAR system, the one or more signal shapers 150 and/or the one or more scanners 152 can be configured to operate on the core output signal such that the system is collimated or substantially collimated as it travels away from the LIDAR system. In some instances, the one or more signal shapers 150 and/or the one or more scanners 152 are configured to operate on the core output signal such that the system output signal diverges as it travels away from the LIDAR system.

A LIDAR system constructed as shown in FIG. 6A can serve as a secondary LIDAR system. For instance, a secondary LIDAR system can include a LIDAR chip constructed according to FIG. 2A serving as the core, a LIDAR chip constructed according to FIG. 2B in combination a LIDAR adapter constructed according FIG. 3A serving as the core, a LIDAR chip constructed according to FIG. 2C in combination a LIDAR adapter constructed according FIG. 4 serving as the core, a LIDAR assembly constructed according to FIG. 5A serving as the core, or a LIDAR assembly constructed according to FIG. 5B serving as the core. When a secondary LIDAR system is constructed as disclosed in the context of FIG. 6A, the one or more scanners 152 can be operated so as to scan the system output signals transmitted from the secondary LIDAR system as illustrated by the arrow labeled A in FIG. 1C.

FIG. 6B illustrates a LIDAR system that includes multiple cores. One or more components selected from a group consisting of the LIDAR chips, the combinations of LIDAR chip and LIDAR adapter, and the LIDAR assemblies can each serve as one of the LIDAR cores in the LIDAR system. Each of the LIDAR cores can be constructed as disclosed in the context of FIG. 2A through FIG. 5B or can have an alternate construction. Each of the LIDAR cores outputs a core output signal. For instance, when a LIDAR chip serves as a core, the LIDAR output signal output from the LIDAR chip can serve as a core output signal. When a LIDAR chip in combination with a LIDAR adapter serves as a core the LIDAR output signal output from the LIDAR adapter can serve as a core output signal. When a LIDAR assembly serves as a core the LIDAR output signal output from the LIDAR adapter can serve as a core output signal.

The cores need not be distinct as shown in FIG. 6B. For instance, the components from different cores can be combined. As an example, the cores can each have a different light source, or a single light source can serve as a light source for multiple cores. As another example, the outgoing LIDAR signals from different cores can be combined on a common waveguide. Further, the individual cores need not be identifiable as LIDAR system that concurrently output multiple system output signals and can generate the preliminary LIDAR data from each of the system output signals can serve as the preliminary LIDAR system. Examples of LIDAR chips, LIDAR cores, LIDAR assemblies, and LIDAR systems that can included in or used as a preliminary LIDAR system and/or a secondary LIDAR system can be found in U.S. Pat. No. 11,714,167 with U.S. patent application Ser. No. 16/547,522, filed on Aug. 21, 2019, entitled “LIDAR Adapter for Use with LIDAR Chip,” and incorporated herein in its entirety.

When the preliminary LIDAR system concurrently output multiple system output signals and can generate the preliminary LIDAR data from each of the system output signals, the light source controller 32 can be configured to operate the one or more light sources that are the source of system output signals transmitted from the preliminary LIDAR system. Additionally, the scanner controller 34 can be configured to operate the one or more scanners that steer the system output signals transmitted from the preliminary LIDAR system. Further, the light source controller 32 can include one or more data processors where one or more of the data processors processes the composite signals that each receives light from one of the system output signals.

The LIDAR system can include one or more signal shapers that each receives one or more of the core output signals. In some instances, the LIDAR system includes signal shapers arranged such that one or more of the signal shapers receives a core output signal output from one or more other signal shapers. FIG. 6B shows the core output signals received by a single signal shaper 150. As an alternative to a single signal shaper that receives the core output signals, the core output signals can each be received by a different signal shaper. Alternately, the LIDAR system can include a selection of signal shapers 150 arranged such that a portion of the signal shapers receive one of the core output signals and a second portion of the signal shapers receive multiple core output signals. The signal shapers are configured to shape the core output signals. Suitable signal shapers 150 include, but are not limited to, lenses such as convex lenses and mirrors such as concave mirrors. Accordingly, a signal shaper 150 can be configured to focus, expand, or collimate a core output signal.

The shaped core output signals output from the one or more signal shapers 150 are received by one or more scanners 152 that output the core output signals as system output signals traveling away from the LIDAR system. The system output signals from each of the cores can serve as one of the system output signals illustrated in FIG. 1B. Accordingly, the system output signals are labeled as shown in FIG. 1B with the channel labels C₁ through C₄.

The directions that the system output signals travel away from the LIDAR system are labeled d₂ in FIG. 6B. A scanner controller 34 can operate the one or more scanners 152 so as to steer each of the core output signals to different in a detection space or an identification region 44. As is evident from the arrows labeled A and B in FIG. 6B, the one or more scanners 152 can be configured such that the scanner controller 34 can steer the core output signals in one, two, or three dimensions. As a result, the one or more scanners 152 can function as a beam-steering mechanism that is operated by a scanner controller 34 so as to steer the system output signals within the field of view of the LIDAR system. Suitable scanners 152 include, but are not limited to, movable mirrors, MEMS mirrors, optical phased arrays (OPAs), optical gratings, and actuated optical gratings.

In some instances, the one or more signal shapers 150 and/or the one or more scanners 152 are configured to operate on the core output signals such that the system output signals are collimated or substantially collimated as they travel away from the LIDAR system. In some instances, the one or more signal shapers 150 and/or the one or more scanners 152 are configured to operate on the core output signals such that the system output signals expand as they travel away from the LIDAR system. For instance, when the LIDAR system serves as a preliminary LIDAR system, the one or more signal shapers 150 and/or the one or more scanners 152 can be configured to operate on the core output signal such that all or a portion of the system output signals are collimated or substantially collimated as the travel away from the LIDAR system.

A LIDAR system constructed as shown in FIG. 6B can serve as a preliminary LIDAR system. For instance, a preliminary LIDAR system can include a LIDAR chip constructed according to FIG. 2A as all or a portion of the cores, a LIDAR chip constructed according to FIG. 2B in combination a LIDAR adapter constructed according FIG. 3A as all or a portion of the cores, a LIDAR chip constructed according to FIG. 2C in combination a LIDAR adapter constructed according FIG. 4 as all or a portion of the cores, a LIDAR assembly constructed according to FIG. 5A and/or FIG. 5B as all or a portion of the cores. When a primary LIDAR system is constructed as disclosed in the context of FIG. 6B, the one or more scanners 152 can be operated so as to scan the system output signals transmitted from the secondary LIDAR system as illustrated by the arrow labeled A in FIG. 1B.

A comparison of FIG. 1B and FIG. 1C shows that a system output signal transmitted by the preliminary LIDAR system has a larger width than a system output signal transmitted by the secondary LIDAR system has a larger width. In some instances, the preliminary LIDAR system is configured such that at a distance of 1 km, 5 km, and/or 10 km from the preliminary LIDAR system, the width of all or a portion of the system output signals transmitted by the preliminary LIDAR system is more than 1,000, 5,000, or 10,000 times the width of all or a portion of the system output signals transmitted by the secondary LIDAR system at the distance of 1 km, 5 km, or 10 km from the secondary LIDAR system.

In some instances, the preliminary LIDAR system is configured such that at a distance greater than or equal to 1 km, 5 km, or 10 km from the preliminary LIDAR system, the width of all or a portion of the system output signals transmitted by the preliminary LIDAR system is more than 5 m, 10 m, or 20 m and less than 30 m, 50 m, or 100 m. In some instances, the secondary LIDAR system is configured such that at a distance greater than or equal to 1 km, 5 km, or 10 km from the secondary LIDAR system, the width of all or a portion of the system output signals transmitted by the secondary LIDAR system is more than 5 cm, 10 cm, or 20 cm and less than 30 cm, 50 cm, or 100 cm.

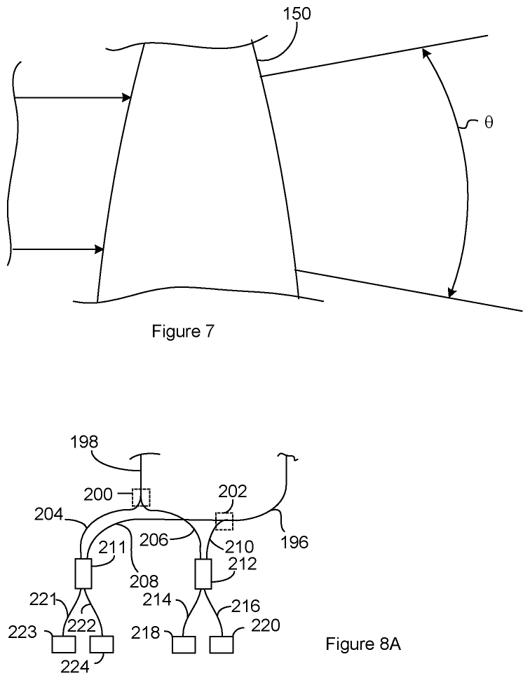

The desired dimension for the system output signals transmitted from the preliminary LIDAR system can be achieved using diverging system output signals. For instance, one or more signal shapers 150 can be configured to provide the system output signals transmitted from the preliminary LIDAR system with the desired dimensions. FIG. 7 illustrates a signal shaper 150 configured to cause a core output signal to diverge at divergence angle θ. When the signal scanner 152 is a mirror, the divergence of the core output signal can be retained, or substantially retained, in the resulting system output signal. Suitable divergence angles for all or a portion of the system output signals transmitted from the preliminary LIDAR system, include, but are not limited to, angles greater than or equal to 0.1°, 0.2°, or 0.4° and less than 0.6°, 0.8°, or 1°.

A signal shaper 150 can also be configured to provide desired dimensions for the one or more system output signals transmitted from the secondary LIDAR system. For instance, one or more signals signal shaper 150 can be configured to provide collimation, or further collimation, of a core output signal and accordingly of the resulting system output signal. Suitable divergence angles for all or a portion of the system output signals transmitted from the secondary LIDAR system, include, but are not limited to, angles greater than 0.001°, 0.004°, or 0.008° and less than 0.01°, 0.02°, or 0.03°.

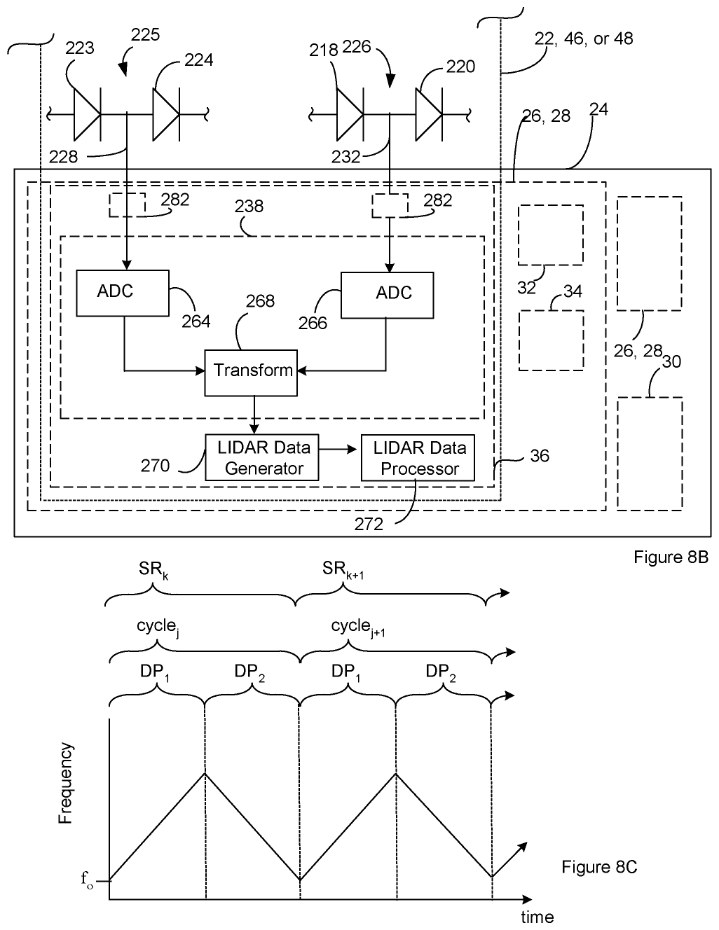

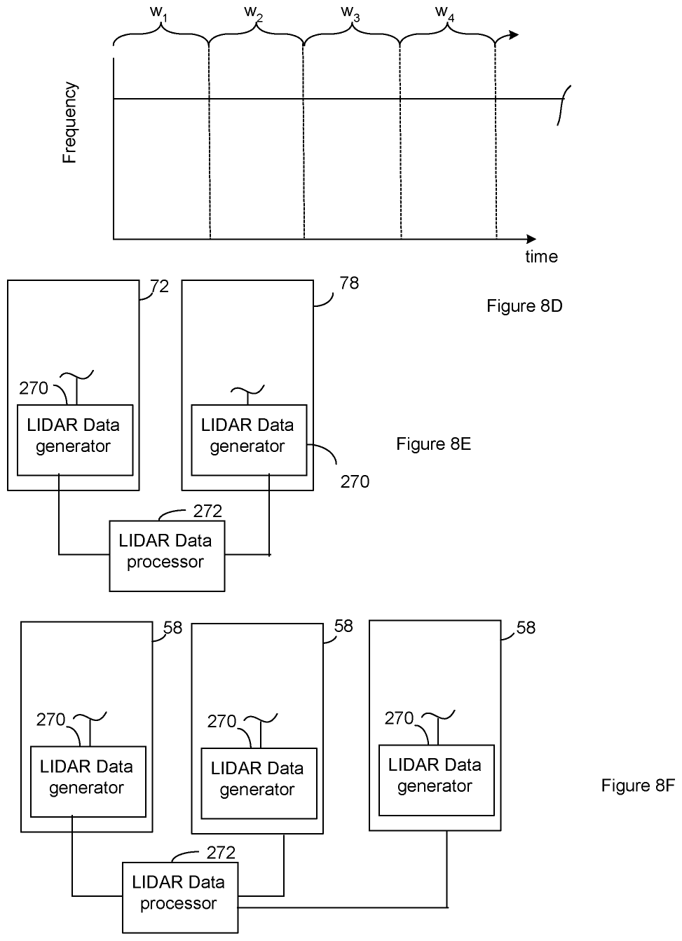

FIG. 8A through FIG. 8C illustrate an example of a suitable signal processor for use as all or a fraction of the signal processors selected from the group consisting of the signal processor 58, the first signal processor 72 and the second signal processor 74. The signal processor receives a comparative signal from a comparative waveguide 196 and a reference signal from a reference waveguide 198. The comparative waveguide 54 and the reference waveguide 56 shown in FIG. 2A and FIG. 2B can serve as the comparative waveguide 196 and the reference waveguide 198, the comparative waveguide 54 and the first reference waveguide 68 shown in FIG. 2C can serve as the comparative waveguide 196 and the reference waveguide 198, or the second comparative waveguide 76 and the second reference waveguide 70 shown in FIG. 2C can serve as the comparative waveguide 196 and the reference waveguide 198.

The signal processor includes a second splitter 200 that divides the comparative signal carried on the comparative waveguide 196 onto a first comparative waveguide 204 and a second comparative waveguide 206. The first comparative waveguide 204 carries a first portion of the comparative signal to the light-combining component 211. The second comparative waveguide 208 carries a second portion of the comparative signal to the second light-combining component 212.

The signal processor includes a first splitter 202 that divides the reference signal carried on the reference waveguide 198 onto a first reference waveguide 208 and a second reference waveguide 210. The first reference waveguide 208 carries a first portion of the reference signal to the light-combining component 211. The second reference waveguide 210 carries a second portion of the reference signal to the second light-combining component 212. Suitable splitters for use as the first splitter and/or the second splitter 200 include, but are not limited to, directional couplers, optical couplers, Y-junctions, tapered couplers, and Multi-Mode Interference (MMI) devices.

The second light-combining component 212 combines the second portion of the comparative signal and the second portion of the reference signal into a second composite signal. Due to the difference in frequencies between the second portion of the comparative signal and the second portion of the reference signal, the second composite signal is beating between the second portion of the comparative signal and the second portion of the reference signal.

The second light-combining component 212 also splits the resulting second composite signal onto a first auxiliary detector waveguide 214 and a second auxiliary detector waveguide 216. The first auxiliary detector waveguide 214 carries a first portion of the second composite signal to a first auxiliary light sensor 218 that converts the first portion of the second composite signal to a first auxiliary electrical signal. The second auxiliary detector waveguide 216 carries a second portion of the second composite signal to a second auxiliary light sensor 220 that converts the second portion of the second composite signal to a second auxiliary electrical signal. Examples of suitable light sensors include germanium photodiodes (PDs), and avalanche photodiodes (APDs).

In some instances, the second light-combining component 212 splits the second composite signal such that the portion of the comparative signal (i.e. the portion of the second portion of the comparative signal) included in the first portion of the second composite signal is phase shifted by 180° relative to the portion of the comparative signal (i.e. the portion of the second portion of the comparative signal) in the second portion of the second composite signal but the portion of the reference signal (i.e. the portion of the second portion of the reference signal) in the second portion of the second composite signal is not phase shifted relative to the portion of the reference signal (i.e. the portion of the second portion of the reference signal) in the first portion of the second composite signal. Alternately, the second light-combining component 212 splits the second composite signal such that the portion of the reference signal (i.e. the portion of the second portion of the reference signal) in the first portion of the second composite signal is phase shifted by 180° relative to the portion of the reference signal (i.e. the portion of the second portion of the reference signal) in the second portion of the second composite signal but the portion of the comparative signal (i.e. the portion of the second portion of the comparative signal) in the first portion of the second composite signal is not phase shifted relative to the portion of the comparative signal (i.e. the portion of the second portion of the comparative signal) in the second portion of the second composite signal. Examples of suitable light sensors include germanium photodiodes (PDs), and avalanche photodiodes (APDs).

The first light-combining component 211 combines the first portion of the comparative signal and the first portion of the reference signal into a first composite signal. Due to the difference in frequencies between the first portion of the comparative signal and the first portion of the reference signal, the first composite signal is beating between the first portion of the comparative signal and the first portion of the reference signal.

The first light-combining component 211 also splits the first composite signal onto a first detector waveguide 221 and a second detector waveguide 222. The first detector waveguide 221 carries a first portion of the first composite signal to a first light sensor 223 that converts the first portion of the second composite signal to a first electrical signal. The second detector waveguide 222 carries a second portion of the second composite signal to a second light sensor 224 that converts the second portion of the second composite signal to a second electrical signal. Examples of suitable light sensors include germanium photodiodes (PDs), and avalanche photodiodes (APDs).

In some instances, the light-combining component 211 splits the first composite signal such that the portion of the comparative signal (i.e. the portion of the first portion of the comparative signal) included in the first portion of the composite signal is phase shifted by 180° relative to the portion of the comparative signal (i.e. the portion of the first portion of the comparative signal) in the second portion of the composite signal but the portion of the reference signal (i.e. the portion of the first portion of the reference signal) in the first portion of the composite signal is not phase shifted relative to the portion of the reference signal (i.e. the portion of the first portion of the reference signal) in the second portion of the composite signal. Alternately, the light-combining component 211 splits the composite signal such that the portion of the reference signal (i.e. the portion of the first portion of the reference signal) in the first portion of the composite signal is phase shifted by 180° relative to the portion of the reference signal (i.e. the portion of the first portion of the reference signal) in the second portion of the composite signal but the portion of the comparative signal (i.e. the portion of the first portion of the comparative signal) in the first portion of the composite signal is not phase shifted relative to the portion of the comparative signal (i.e. the portion of the first portion of the comparative signal) in the second portion of the composite signal.

When the second light-combining component 212 splits the second composite signal such that the portion of the comparative signal in the first portion of the second composite signal is phase shifted by 180° relative to the portion of the comparative signal in the second portion of the second composite signal, the light-combining component 211 also splits the composite signal such that the portion of the comparative signal in the first portion of the composite signal is phase shifted by 180° relative to the portion of the comparative signal in the second portion of the composite signal. When the second light-combining component 212 splits the second composite signal such that the portion of the reference signal in the first portion of the second composite signal is phase shifted by 180° relative to the portion of the reference signal in the second portion of the second composite signal, the light-combining component 211 also splits the composite signal such that the portion of the reference signal in the first portion of the composite signal is phase shifted by 180° relative to the portion of the reference signal in the second portion of the composite signal.

Suitable light signal combiners that can serve as the light-combining component 211 and/or the second light-combining component 212 include, but are not limited to, a Multi-Mode Interference (MMI) device such as a 2×2 MMI device. Other suitable light signal combiners include, but are not limited to, adiabatic splitters, and directional couplers. In some instances, the functions of the illustrated light signal combiner 286 are performed by more than one optical component or a combination of optical components.

The first reference waveguide 208 and the first reference waveguide 210 are constructed to provide a phase shift between the first portion of the reference signal and the second portion of the reference signal. For instance, the first reference waveguide 208 and the second reference waveguide 210 can be constructed so as to provide a 90-degree phase shift between the first portion of the reference signal and the second portion of the reference signal. As an example, one reference signal portion can be an in-phase component and the other a quadrature component. Accordingly, one of the reference signal portions can be a sinusoidal function and the other reference signal portion can be a cosine function. In one example, the first reference waveguide 208 and the second reference waveguide 210 are constructed such that the first reference signal portion is a cosine function, and the second reference signal portion is a sine function. Accordingly, the portion of the reference signal in the second composite signal is phase shifted relative to the portion of the reference signal in the first composite signal, however, the portion of the comparative signal in the first composite signal is not phase shifted relative to the portion of the comparative signal in the second composite signal.

The first light sensor 223 and the second light sensor 224 can be connected as a balanced detector and the first auxiliary light sensor 218 and the second auxiliary light sensor 220 can also be connected as a balanced detector. For instance, FIG. 8B provides a schematic of the relationship between the electronics 24, the first light sensor 223, the second light sensor 224, the first auxiliary light sensor 218, and the second auxiliary light sensor 220. The symbol for a photodiode is used to represent the first light sensor 223, the second light sensor 224, the first auxiliary light sensor 218, and the second auxiliary light sensor 220 but one or more of these sensors can have other constructions. In some instances, all of the components illustrated in the schematic of FIG. 8B are included on the LIDAR chip. In some instances, the components illustrated in the schematic of FIG. 8B are distributed between the LIDAR chip and other locations of the aerial device detection system. For instance, the components illustrated in the schematic of FIG. 8B can be distributed between the LIDAR chip and the electronics housing 42.

The first light sensor 223 and the second light sensor 224 are connected as a first balanced detector 225. The first auxiliary light sensor 218 and the second auxiliary light sensor 220 are connected as a second balanced detector 226. In particular, the first light sensor 223 and the second light sensor 224 are connected in series. Additionally, the first auxiliary light sensor 218 and the second auxiliary light sensor 220 are connected in series. The serial connection in the first balanced detector is in communication with a first data line 228 that carries the output from the first balanced detector as a first data signal. The serial connection in the second balanced detector is in communication with a second data line 232 that carries the output from the second balanced detector as a second data signal. The first data signal is an electrical representation of the first composite signal and the second data signal is an electrical representation of the second composite signal. Accordingly, the first data signal includes a contribution from a first waveform and a second waveform, and the second data signal is a composite of the first waveform and the second waveform. The portion of the first waveform in the first data signal is phase-shifted relative to the portion of the first waveform in the first data signal but the portion of the second waveform in the first data signal being in-phase relative to the portion of the second waveform in the first data signal. For instance, the second data signal includes a portion of the reference signal that is phase shifted relative to a different portion of the reference signal that is included the first data signal. Additionally, the second data signal includes a portion of the comparative signal that is in-phase with a different portion of the comparative signal that is included in the first data signal. The first data signal and the second data signal are beating as a result of the beating between the comparative signal and the reference signal, i.e. the beating in the first composite signal and in the second composite signal.

The electronics 24 include a data processor 36 having a beat frequency identifier 238 configured to perform a mathematical transform on the first data signal and the second data signal. The beat frequency identifier 238 receives the first data signal and the second data signal. Since the first data signal is an in-phase component and the second data signal its quadrature component, the first data signal and the second data signal together act as a complex data signal where the first data signal is the real component, and the second data signal is the imaginary component of the complex data signal.

The beat frequency identifier 238 includes a first Analog-to-Digital Converter (ADC) 264 that receives the first data signal from the first data line 228. The first Analog-to-Digital Converter (ADC) 264 converts the first data signal from an analog form to a digital form and outputs a first digital data signal. The beat frequency identifier 238 includes a second Analog-to-Digital Converter (ADC) 266 that receives the second data signal from the second data line 232. The second Analog-to-Digital Converter (ADC) 266 converts the second data signal from an analog form to a digital form and outputs a second digital data signal. The first digital data signal is a digital representation of the first data signal and the second digital data signal is a digital representation of the second data signal. Accordingly, the first digital data signal and the second digital data signal act together as a complex signal where the first digital data signal acts as the real component of the complex signal and the second digital data signal acts as the imaginary component of the complex data signal.

The beat frequency identifier 238 includes a mathematical transformer 268 that receives the complex data signal. For instance, the mathematical transformer 268 receives the first digital data signal from the first Analog-to-Digital Converter (ADC) 264 as an input and also receives the second digital data signal from the second Analog-to-Digital Converter (ADC) 266 as an input. The mathematical transformer 268 can be configured to perform a mathematical transform on the complex signal so as to convert from the time domain to the frequency domain. The mathematical transform can be a complex transform such as a complex Fast Fourier Transform (FFT). A complex transform such as a complex Fast Fourier Transform (FFT) provides an unambiguous solution for the shift in frequency of LIDAR input signal relative to the LIDAR output signal that is caused by the radial velocity between the reflecting object and the LIDAR chip.

The mathematical transformer 268 can include a peak finder (not shown) configured to identify peaks in the output of the mathematical transformer 268. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The data processor 237 includes a LIDAR data generator 270 that receives the beat frequency of the composite signal from the peak finder. The LIDAR data generator 270 processes the beat frequency of the composite signal so as to generate LIDAR data or the preliminary LIDAR data.

The LIDAR data generated at the LIDAR data generator 270 is received at a LIDAR data processor 272 configured to perform further processing of the LIDAR data. Alternately, the preliminary LIDAR data generated at the LIDAR data generator 270 is received at the LIDAR data processor 272 configured to perform further processing of the preliminary LIDAR data.

Although FIG. 8A illustrates light-combining components that combine a portion of the reference signal with a portion of the comparative signal, the signal processor can include a single light-combining component that combines the reference signal with the comparative signal so as to form a composite signal. As a result, at least a portion of the reference signal and at least a portion of the comparative signal can be combined to form a composite signal. The combined portion of the reference signal can be the entire reference signal, or a fraction of the reference signal and the combined portion of the comparative signal can be the entire comparative signal or a fraction of the comparative signal.

When the LIDAR system is a secondary LIDAR system, the secondary LIDAR system is configured to generate LIDAR data. LIDAR data can be generated from system output signals having a frequency versus time pattern with multiple chirp periods repeated in cycles. For instance, the light source controller 32 can tune the frequency of a system output signal so as to provide the desired frequency versus time pattern. FIG. 8C shows an example of a suitable frequency versus time pattern for the system output signal. The base frequency of the system output signal (fₒ) can be the frequency of the system output signal at the start of a cycle.

FIG. 8C shows frequency versus time for a sequence of two cycles labeled cycleⱼ and cycleⱼ₊₁. In some instances, the frequency versus time pattern is repeated in each cycle as shown in FIG. 8C. The illustrated cycles do not include re-location periods and/or re-location periods are not located between cycles. As a result, FIG. 8C illustrates the results for a continuous scan.

Each cycle includes M chirp periods that are each associated with a period index m and are labeled DPₘ. In the example of FIG. 8C, each cycle includes two chirp periods labeled DPₘ with m=1 and 2. The sequence of chirp periods is repeated in each cycle. The frequency chirp in different chirp periods can have different chirp rates and/or different directions. In some instances, the frequency versus time pattern is the same for the chirp periods that correspond to each other in different cycles as is shown in FIG. 8C. Corresponding chirp periods are chirp periods with the same period index. As a result, each chirp period DP₁ can be considered corresponding chirp periods and the associated frequency versus time patterns are the same in FIG. 8C. At the end of a cycle, a light source controller 32 can return the frequency to the same frequency level at which it started the previous cycle.

During the chirp period DPₘ, the light source controller 32 operate the light source such that the frequency of the system output signal changes at a linear rate αₘ (the chirp rate). In some instances, the chirp rate can be zero in a chirp period.

FIG. 8C labels data regions that are each associated with a data region index k and are labeled SRₖ. FIG. 8C labels data regions SRₖ₋₁ through SRₖ₊₁. Each data region is illuminated with the system output signal during the chirp periods that FIG. 8C shows as associated with the data region. For instance, data region SRₖ₊₁ is illuminated with the system output signal during the chirp period labeled DP₂ within cycle j+1 and the chirp period labeled DP₁ within cycle j+1. Accordingly, the data region labeled SRₖ₊₁ is associated with the chirp periods labeled DP₁ and DP₂ within cycle j+1. The data region indices k can be assigned relative to time. For instance, the samples regions can be illuminated by the system output signal in the sequence indicated by the index k. As a result, the data region SR₁₀ can be illuminated after data region SR₉ and before SR₁₁.

The frequency output from the Complex Fourier transform represents the beat frequency of the composite signals that each includes a comparative signal beating against a reference signal. The beat frequencies from two or more different chirp periods that are associated with the same data region can be combined to generate the LIDAR data. For instance, the beat frequency determined from DP₁ associated with data region SRₖ can be combined with the beat frequency determined from DP₂ associated with SRₖ to determine the LIDAR data for data region SRₖ. As an example, the following equation applies during a chirp period where the frequency of the outgoing LIDAR signal increases during the chirp period such as occurs in chirp period DP₁ of FIG. 8C: f_{ub}=−f_{d}+αᵤτ where f_{ub} is the frequency provided by the transform component, fa represents the Doppler shift (f_{d}=2Vₖf_{c}/c) where f_{c} represents the optical frequency (fₒ), c represents the speed of light, Vₖ is the radial velocity between the reflecting object and the LIDAR core where the direction from the reflecting object toward the chip is assumed to be the positive direction, c is the speed of light, and αᵤ represents a chirp rate (αₘ) for the chirp period where the frequency of the system output signal increases with time (α₁ in this case).

The following equation applies during a chirp period where the frequency of the outgoing LIDAR signal decreases such as occurs in chirp period DP₂ of FIG. 8C: f_{db}=−f_{d}−α_{d}τ where f_{db} is a frequency provided by the transform component, and α_{d} represents the chirp rate (αₘ) for the chirp period where the frequency of the system output signal increases with time (α₂ in this case). In these two equations, fa and t are unknowns. These equations can be solved for the two unknowns and a LIDAR data generator 270 can calculate the radial velocity for data region k (Vₖ) from the Doppler shift (Vₖ=c*f_{d}/(2f_{c})) and/or the separation distance for data region k (Rₖ) can be determined from c*τ/2.

When the LIDAR system is a preliminary LIDAR system, the preliminary LIDAR system is configured to generate the preliminary LIDAR data. As noted above, the preliminary LIDAR data can include the radial velocity between the preliminary LIDAR system 10 and the aerial device but exclude the distance between the preliminary LIDAR system and the aerial device. The preliminary LIDAR data can also exclude any material indicator.

When a LIDAR system is a preliminary LIDAR system, a light source controller 32 can operate the light source 46 such that the system output signal has a frequency that not a function of time. For instance, FIG. 8D is an example of the frequency of each system output signal over time. As a result, the system output signal can be a continuous wave (CW). For instance, the outgoing LIDAR signal for a core and the resulting system output signal can be a continuous wave (CW). As an example, an outgoing LIDAR signal, the resulting LIDAR output signal and the resulting system output signal can be represented by Equation 2: G*cos (H*t) where G and H are constants and t represents time. In some instances, G represents the square root of the power of the outgoing LIDAR signal. The frequency of the system output signal from different cores can be the same or different.

Since the frequency of system output signal is constant, changing the distance between a reflecting object, such as an aerial device, and preliminary LIDAR system does not cause a change to the frequency of the LIDAR input signal. As a result, the separation distance does not contribute to the shift in the frequency of the LIDAR input signal relative to the frequency of the LIDAR output signal. Accordingly, the effect of the separation distance has been removed or substantially from the shift in the frequency of the LIDAR input signal relative to the frequency of the system output signal.

The LIDAR data generator 270 receives the beat frequency of the composite signal from the peak finder. The LIDAR data generator 270 processes the beat frequency of the composite signal so as to generate the preliminary LIDAR data. Since the frequency shift provided by the mathematical transformer 268 does not have input from a frequency shift due to the separation distance between the reflecting object and the LIDAR chip, the LIDAR data generator 270 can approximate the radial velocity between the reflecting object and the LIDAR chip (v) using Equation 4: v=c*f_{d}/(2*f_{c}) where f_{d} is approximated as the peak frequency received from the peak finder, c is the speed of light, and f_{c} represents the frequency of the LIDAR output signal.

Each of the preliminary LIDAR data results is generated from a system output signal that is transmitted for a duration of a measurement window. The durations of the measurement windows are labeled wⱼ in FIG. 8D where j represents a window index. The region of the detection space 8 illuminated by a system output signal during a measurement window is the scan zone. The radial velocity determined from light that illuminates a scan zone can be considered the radial velocity for that scan zone. The spot size of the system output signals transmitted from the preliminary LIDAR system can be large enough that the system return signal becomes weak due to the spot size exceeding the illuminated portion of the aerial device. The duration of the measurement windows can be increased to compensate for the reduced power of the system output signals. Accordingly, in some instances, the duration of the measurement windows is more than 1.1, 10, or 1000 times the duration of all or a portion of the chirp periods.

The first Analog-to-Digital Converter (ADC) 264 converts the first data signal to the first digital data signal by sampling the first data signal at a sampling rate. Similarly, the second Analog-to-Digital Converter (ADC) 266 converts the second data signal to the second digital data signal by sampling the second data signal at a sampling rate. When preliminary LIDAR system uses a continuous wave as the outgoing LIDAR signal, the effects of distance between the reflecting object and LIDAR chip are effectively removed from the beating of the composite signal and the resulting electrical signals. Accordingly, the beat frequency of the composite signal is reduced and the required sampling rate is reduced. For instance, the sampling rate of the Analog-to-Digital Converters in the beat frequency identifier 238 of a secondary LIDAR system can be on the order of 4GSPS. In contrast, the sampling rate of the Analog-to-Digital Converters in the beat frequency identifier 238 of a secondary LIDAR system can be on the order of 400MSPS.

Although the signal processor of FIG. 8A and FIG. 8B are disclosed in the context of a complex data signal, a real data signal can be used. As a result, the signal processor of FIG. 8A and FIG. 8B can be modified so as to exclude the components associated with the generation of the second data signal and the mathematical transformer 268 can perform a real Fourier Transform (FFT). Accordingly, the signal processor can include a single light-combining component 211 and a single Analog-to-Digital Converters (ADC).

The sampling rates for the ADC(s) in the beat frequency identifiers 238 of the preliminary LIDAR system can be lower than the sampling rates for the ADC(s) in all or a portion of the beat frequency identifier 238 of the secondary LIDAR system. In some instances, the ADC(s) in all or a portion of the beat frequency identifiers 238 in the preliminary LIDAR system have sampling rates greater than 100, 200, or 300 and less than 500, 800, or 1000 MSPS (mega-samples per second) and/or the ADC(s) in all or a portion of the beat frequency identifiers 238 in the secondary LIDAR system have sampling rates greater than 1, 2, or 3 and less than 5, 8, or 10 GSPS (giga-samples per second). In some instances, a ratio of the sampling rates for the ADC(s) in all or a portion of the beat frequency identifiers 238 in the secondary LIDAR system: the sampling rates for the ADC(s) in all or a portion of the beat frequency identifiers 238 in the preliminary LIDAR is greater than 2:1, 5:1, or 10:1 and less than 15:1, 50:1, or 100:1. Additionally or alternately, the preliminary LIDAR system can be a lower bandwidth system than the secondary LIDAR system where the bandwidth of a LIDAR system represents the range of beat frequencies used to generate the preliminary LIDAR data by the LIDAR system. As an example, the light detectors in the preliminary LIDAR system can be used with Transimpedance Amplifiers (TIAs) that convert the current of the resulting data signal output from the light detectors to a voltage. For instance, FIG. 8B illustrates Transimpedance Amplifiers 282 that are optionally positioned along the first data line 228 and the second data line 232 so as to convert the current of the first data signal to a voltage and so as to convert the current of the second data signal to a voltage. The Transimpedance Amplifiers (TIAs) and the associated circuitry in the preliminary LIDAR system can be configured to operate at lower bandwidth than the Transimpedance Amplifiers (TIAs) and the associated circuitry in the secondary LIDAR system. In some instances, the preliminary LIDAR system includes one or more cores that operate at a bandwidth range of more than 0.1 GHz, 0.2 GHz, or 0.3 GHz and less than 0.5 GHZ, 1 GHz, or 2 GHz and the preliminary LIDAR system includes one or more cores that operate at a bandwidth range of more than 0.5 GHZ, 1 GHZ, or 1.5 GHz and less than 2 GHZ, 3 GHZ, or 5 GHz. In some instances, a ratio of the bandwidth for all or a portion of cores in the secondary LIDAR system: the bandwidth for all or a portion of cores in the primary LIDAR assembly is greater than 2:1, 4:1, or 8:1 and less than 10:1, 15:1, or 20:1. The reduced bandwidth requirements of the preliminary LIDAR system relative to the secondary LIDAR system allows the preliminary LIDAR system to operate at lower frequencies and accordingly reduces the costs associated with the components of the preliminary LIDAR system. In some instances, the preliminary LIDAR systems has TIAs that operate at a bandwidth range of more than 0.1 GHZ, 0.2 GHz, or 0.3 GHZ and less than 0.5 GHz, 1 GHZ, or 2 GHz and the secondary LIDAR system has TIAs that operate at a bandwidth range of more than 0.5 GHz, 1 GHZ, or 1.5 GHz and less than 2 GHZ, 3 GHZ, or 5 GHz. In some instances, a ratio of the bandwidth for the TIAs in the secondary LIDAR system: the bandwidth for the TIAs in primary LIDAR system is greater than 2:1, 4:1, or 8:1 and less than 10:1, 15:1, or 20:1.

When the LIDAR system is a secondary LIDAR system with a signal processor 58 constructed according to FIG. 8B, the LIDAR data processor 272 in FIG. 8B receives LIDAR data from the LIDAR data generator 270. The LIDAR data received by the LIDAR data processor 272 can be the LIDAR data from all or a portion of the data regions in an identification region 44 within which a preliminary LIDAR system have identified the presence of an object that may be an aerial device such as a drone. The LIDAR data processor 272 can compile the LIDAR data so as to generate an experimental VD pattern. A VD pattern is a pattern of velocity points distributed in space. Accordingly, the LIDAR data can be processed so as to determine the distribution of velocity values within the identification region. In some instances, a VD pattern is a pattern of velocity points distributed in space that changes with time. As a result, the secondary LIDAR system can scan the identification region multiple times and the LIDAR data results processed so as to identify a distribution of velocity values within the identification region over time that can serve as the experimental VD pattern.

The LIDAR data processor 272 can compare the experimental VD pattern to the pre-determined VD patterns of one or more aerial devices stored in a storage device. The experimental velocity pattern can be compared to stored VD patterns of one or more aerial devices to determine if a match is present. The match identification algorithm can be configured such that when a match is present, the object within the identification region 44 is determined to be an aerial device but when a match is not present, the object within the identification region 44 is determined not to be an aerial device.

When an object within an identification region 44 is determined to be an aerial device, the LIDAR data processor 272 can communicate to the response controller 40 that an aerial device has been found in the identification region. In some instances, the storage device associates different pre-determined VD patterns with different types of aerial devices. In these instances, the LIDAR data processor 272 can communicate to the response controller 40 the type of aerial device that has been found in the identification region. Examples of different types of aerial devices include, but are not limited to, balloons including foil covered polyester resin balloons, planes, helicopters, model planes, model helicopters, and toys such as kites.

The response controller 40 can take one or more responses in response to the determination that an aerial device has been found in the identification region. Alternately, response controller 40 can take one or more responses in response to the type of aerial device that has been found in the identification region. Different responses can be associated different types of aerial devices. An example of a response to a determination that a drone is present in the identification region, includes but is not limited to, activating one or more signal jammers so as to prevent the ability of the drone to send and/or receive signals. Another example of a response is to take no action. For instance, an example of a response to a determination that a helicopter or bird is present in the identification region is to take no action regarding the helicopter.

FIG. 8B illustrates the LIDAR data processor 272 receiving LIDAR data from a single signal processor, however, the LIDAR data processor 272 can receive LIDAR data from more than one signal processor included in a preliminary LS controller 26 or a secondary LS controller 28. For instance, when the LIDAR system includes an adapter disclosed in the context of FIG. 2C and/or the LIDAR assembly of FIG. 5B, the first signal processor 72 and the second signal processor 46 can each be constructed according to FIG. 8B with the LIDAR data processor 272 receiving LIDAR data results from the LIDAR data generator 270 in the first signal processor 72 and also receiving LIDAR data results from the LIDAR data generator 270 in the second signal processor 46 as shown in FIG. 8E.

In FIG. 8E, the LIDAR data processor 272 can receive multiple LIDAR data results for different data regions. For instance, for all or a portion of the data regions in an identification region, the LIDAR data processor 272 can receive a first LIDAR data result for the data region from the LIDAR data generator 270 in the first signal processor 72 and a second LIDAR data result for the same data region from the LIDAR data generator 270 in the second signal processor 74. The LIDAR data processor 272 can combine the LIDAR data results for the same data region to generate the representative LIDAR data for the data region. Combining the LIDAR data can include taking an average, median, or mode of different LIDAR data results generated for the same data region. For instance, a LIDAR data processor 272 can average the distance between the LIDAR system and an aerial object determined from the first data results with the distance determined from the second data results and/or a LIDAR data processor 272 can average the radial velocity between the LIDAR system and the aerial object from the first data results with the radial velocity between the LIDAR system and the aerial object from the second data results.

In some instances, determining the LIDAR data for a data region includes identifying the LIDAR data result that most represents reality (the representative LIDAR data). For instance, a LIDAR data processor 272 can identify the first data result or the second data result for the same data region as the LIDAR data that is most represents reality (the representative LIDAR data). The LIDAR data from the identified LIDAR data result can serve as the representative LIDAR data to be used for additional processing. As an example, the LIDAR data result generated from the signal (composite signal or the second composite signal) with the larger amplitude can be identified as having the representative LIDAR data and the LIDAR data from the identified signal can be used for further processing by the LIDAR data processor 272. In some instances, identifying the LIDAR data result with the representative LIDAR data is combined with combining different LIDAR data results. For instance, a LIDAR data processor 272 can identify each of the composite signals with an amplitude above an amplitude threshold as the source of representative LIDAR data and when more than two composite signals are identified as having representative LIDAR data, the LIDAR data processor 272 can combine the LIDAR data generated from each of identified composite signals. When one composite signal is identified as having representative LIDAR data, the data processor 36 can use the LIDAR data from that composite signal as the representative LIDAR data. When none of the composite signals is identified as having representative LIDAR data, the LIDAR data for the data region associated with those composite signals can be discarded.

The LIDAR data processor 272 can also be configured to generate a material indicator for all or a portion of the data regions. As noted above, a first portion of the system return signal and a second portion of the system return signal can each be associated with a different polarization state. The portion of the light in the system return signal that retains the polarization state in which it was transmitted can serve as retained state light. The portion of the light in the system return signal that has its polarization state change in response to reflection by an aerial device can serve as changed state light. An example of an indicator of the material from which the reflecting object is constructed is a signal level ratio such as a ratio of a signal level of the retained state light: the signal level of the changed state light. In some instances, the signal level is the signal magnitude or signal power. One example of a suitable signal level ratio is a polarization state power ratio represented by a ratio of the power of the retained state light: the power of the changed state light.

In one example of the LIDAR data processor 272 generating a material indicator that includes or consists of the polarization state power ratio, a secondary LIDAR system is configured such that the peaks identified by the peak finder in the first signal processor 72 are generated from the retained state light and the peaks identified by the peak finder in the second signal processor 74 are generated from the changed state light. The composite signal generated in the first signal processor 72 from light that illuminates a subject data region during a subject chirp period can serve as a retained state light signal and the composite signal generated in the second signal processor 74 from light that illuminates the subject data region during the subject chirp period can serve as a changed state light signal. The LIDAR data processor 272 can calculate a material indicator for the subject data region by calculating a ratio of the power of the retained state light signal at the frequency identified for the subject chirp period by the peak finder in the first signal processor 72: the power of the changed state light signal at the frequency identified for the subject chirp period by the peak finder in the second signal processor 74. As a result, the polarization state power ratio can be calculated from the magnitudes of the peaks identified by the peak finders. For instance, the LIDAR data processor 272 can calculate a material indicator for a subject one of the data regions by calculating a ratio of the magnitude of the peak that the peak finder in the first signal processor 72 identifies for a subject one of the chirp periods during which the subject data region is illuminated: the magnitude of the peak that the peak finder in the second signal processor 74 identifies for the subject chirp period.

Different object materials cause the system output signal to be reflected at different polarization state power ratios. Examples of materials that can be distinguished by a material indicator such as a polarization state power ratio include, but are not limited to, glasses, plastics such as nylon, woven materials such as cloth, canvass, cardboard including compressed cardboard, feathers, meshes such as window screens, and painted surfaces such as painted metals and painted plastics. As an example, plastics generally have a different polarization state power ratio of about 2 and feathers generally have a different polarization state power ratio of about 7. As a result, a material indicator such as a polarization state power ratio can be used to distinguish between birds, plastic drones, and metals that may be included in airplane bodies or balloons.

When a LIDAR data processor 272 receives multiple LIDAR data results for different data regions as disclosed in the context of FIG. 8E, the LIDAR data processor 272 can calculate one or more material indicators for each data region in all or a portion of the data regions within an identification region. The one or more material indicators calculated for a data region can be in addition to the LIDAR data (the representative LIDAR data) the LIDAR data processor 272 calculated for the data region or an alternative to the LIDAR data (the representative LIDAR data) calculated for the data region.

Material indicators from one or more data regions can be used to identify the material. For instance, the LIDAR data processor 272 can have access to a storage device that contains material identification data associating different materials with different ranges of a material indicator such as the polarization state power ratio. The LIDAR data generator can compare the material indicator to the material indicator ranges so as to identify a match. For instance, the LIDAR data generator can identify one or more materials that each has a material indicator range that encompasses the generated material indicator as being matched materials. When one or more matched materials belong to an aerial device or a combination of the matched materials belong to an aerial device, an object within the identification region 44 can be determined to be an aerial device. When one or more matched materials are not associated with an aerial device or a combination of the matched materials are not associated with an aerial device, the object within the identification region 44 is determined not to be an aerial device. For instance, when one or more matched materials are feathers, the object within the identification region 44 is determined not to be an aerial device.

When an object within an identification region 44 is determined to be an aerial device, the LIDAR data processor 272 can communicate to the response controller 40 that an aerial device has been found in the identification region. In some instances, the storage device associates different materials or combinations of materials with different types of aerial devices. In these instances, the LIDAR data processor 272 can communicate to the response controller 40 the type of aerial device that has been found in the identification region. Examples of different types of aerial devices include, but are not limited to, balloons including foil covered polyester resin balloons, planes, helicopters, model planes, model helicopters, and toys such as kites. As noted above, the response controller 40 can take one or more responses in response to the determination that an aerial device has been found in the identification region and/or can take one or more responses in response to the type of aerial device that has been found in the identification region.

As noted above, the LIDAR data processor 272 can use a material indicator(s) to identify an aerial device within an identification region or use a VD pattern(s) to identify an aerial device within an identification region. In some instances, the LIDAR data processor 272 combines the use of material indicator(s) with the use of VD pattern(s) to identify an aerial device within an identification region. For instance, Artificial Intelligence (AI) trained on object identity as a function of VD patterns and material indicator(s) can analyze the material indicator(s) and experimental VD pattern(s) to identify the object and/or aerial device.

As shown in FIG. 6B, the LIDAR system can be configured to output multiple different system output signals. In some instances, a LIDAR system configured to output multiple different system output signals serves a preliminary LIDAR system with multiple different cores. The cores can be configured as disclosed in the context of FIG. 2A or FIG. 2B. Each of the cores can have a signal processor 58 constructed according to FIG. 8B with the LIDAR data processor 272 receiving preliminary LIDAR data results from the signal processors 58 in the different cores as shown in FIG. 8F.

The mathematical transformers 268, LIDAR data generators 270, and/or the LIDAR data processor 272 can be distinct components. Alternately, two or more components selected from a group consisting of the mathematical transformer 268, the LIDAR data generators 270, and/or the LIDAR data processor 272 can be integrated into a common component.

Accordingly, all or a portion of the components selected from a group consisting of the mathematical transformer 268, the LIDAR data generators 270, and/or the LIDAR data processor 272 can be integrated into one or more common components. The mathematical transformers 268, the LIDAR data generators 270, and/or the LIDAR data processor 272 can execute the attributed functions using firmware, hardware, software or a combination thereof.

Each of the preliminary LIDAR data results is associated with a different scan zone. Because the scan zones from different system output signals can define and/or span the detection space 8, the preliminary LIDAR data from the scan zones of different cores can be stitched together to provide preliminary data for the detection space 8. Accordingly, the LIDAR data processor 272 can identify each of the scan zones in the detection space 8 where an aerial object is identified. For instance, the data processor 36 in the preliminary LS controller 26 can identify each of the scan zones with preliminary LIDAR data showing a radial velocity with a magnitude above a velocity threshold. Each of the scan zones where a radial velocity has a magnitude greater than or equal to a velocity threshold can be identified as having an object. Each of the scan zones where a radial velocity has a magnitude below the velocity threshold can be identified as not having an object.

A scan zone identified as having an object can serve as a subject scan zone. In response to the identification of a subject scan zone, the LIDAR data processor 272 can provide an orientation identifier to the steering controller 38. The orientation identifier can indicate to the steering controller 38 the desired orientation for the secondary LIDAR system. For instance, when the direction of a scan region serves as the direction of the longitudinal axis for the identification region 44 associated with the scan region, the orientation identifier can be the direction of the subject scan zone. When different scan zones are associated with different orientation for the second LIDAR system, the identity of a subject scan zone (z_{i,j}) can serve as an orientation identifier because the steering controller 38 can identify the desired orientation for the second LIDAR system from the association between the scan zones and the desired orientation for the second LIDAR system. The steering controller 38 can operate the one or more actuators so as to provide the secondary LIDAR system with the orientation indicated by the orientation identifier. The steering controller 38 can provide the scanner controller 34 in the secondary LIDAR system with an identification region scan command in response to the secondary LIDAR system having the orientation indicated by the orientation identifier. In response to receipt of the identification region scan command by the scanner controller 34, the scanner controller 34 can operate the one or more scanners 152 so as to perform the identification region scan.

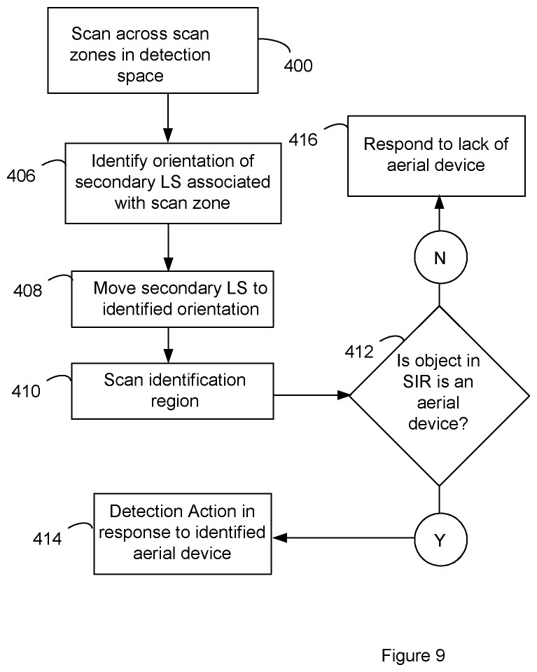

FIG. 9 is an example of a process flow for operating an aerial device detection system. The scan zones in the detection space 8 can be scanned at process block 400. For instance, the scanner controller 34 can operate the one or more scanners 152 such that each of the system output signals transmitted by the preliminary LIDAR system are scanned across the scan zones in the detection space 8. During the scan of the scan zones, the subject scan zones can be identified. For instance, a LIDAR data processor 272 can determine whether an object is present in each of the scan zones. A scan zone where an object is found to be present can serve as a subject scan zone.

In response to the identification of a subject scan zone, the process proceeds to process block 406 where the desired orientation of the secondary LIDAR system is determined. For instance, the steering controller 38 in the ADDS controller 30 can receive an orientation identifier for the subject scan zone from the LIDAR data processor 272. If needed, the steering controller 38 can process the orientation identifier so as to determine and/or calculate the desired orientation of the secondary LIDAR system.

The process can proceed to process block 408 from process block 406. At process block 408, the secondary LIDAR system can be provided with the desired orientation. For instance, the steering controller 38 can operate the one or more actuators 16 so as to provide the secondary LIDAR system with the desired orientation.

The process can proceed to process block 410 from process block 408. At process block 410, the scan of the identification region can be performed. For instance, while the second LIDAR system retains the desired orientation, the scanner controller 34 in the secondary LIDAR system can operate the one or more scanners 152 so as to perform the identification region scan. The one or more LIDAR data generator(s) 270 in each of the signal processors in the secondary LIDAR system 12 can use the light from the system output signals transmitted during the identification region to generate LIDAR data.

The process can proceed to determination block 412 from process block 410. At determination block 412, a determination can be made as to whether the object in the subject scan zone is an aerial device. In some instances, the type of aerial device is identified. For instance, the LIDAR data processor 272 in the secondary LIDAR system 12 can process the LIDAR data to determine if the object identified at determination block 402 is an aerial device and/or identify the type of aerial device.

When the object is determined to be an aerial device at process block 412, the process can proceed to process block 414. At process block 414, a detection action appropriate to the identification of an aerial device in the detection space can be taken in response to the determination that an aerial device has been found in the identification region. For instance, the response controller 40 can disable the aerial devices using an RF jammer. When a type of aerial device is identified, a detection action can be taken in response to the type of aerial device in the identification region. Different detection actions can be associated with different types of aerial devices. An example of a detection actions taken in response to a determination that a drone is present in the identification region, includes but is not limited to, activating one or more signal jammers so as to prevent the ability of the drone to send and/or receive signals. Accordingly, the response controller 40 can activate one or more signal jammers so as to prevent the ability of the drone to send and/or receive signals. The one or more signal jammers can be positioned on the stage such that the signals transmitted by all or a portion of the signal jammer are directed into the identification region and/or encompass the identification region. As a result, the signals transmitted from the one or more signal jammers are received by the aerial object with the identification region.

When the object is determined to not be an aerial device at process block 412, the process can proceed to process block 414. At process block 416, a response appropriate to the lack of an aerial device in the detection space can be taken in response to the determination that an aerial device has not been found in the identification region. For instance, the response controller 40 can take no further action regarding the object detected in the identification region. However, when the LIDAR data includes one or more material indicators, a LIDAR data processor 272 may be able to identify the type of object for an object that is not an aerial device. For instance, a LIDAR data processor 272 may be able to identify snow, rain, leaves, fog, clouds, birds, or other flying animals. As a result, the response controller 40 can make a response in response to the type of object in the identification region. Different responses can be associated with different types of objects. An example of a response to a determination that a bird is present in the identification region, includes but is not limited to, no action.

In some instances, the portion of the process flow associated with process block 400 through 406 and continue while all or a portion of the process flow associated with process blocks 406 to 416 is executed. For instance, a secondary LIDAR system can continue to scan the identification region in response to the identification of a subject scan zone that contains an object while the preliminary LIDAR system continues to scan the detection space 8 so as to identify other scan zones that contain objects.

As noted above, a secondary LIDAR system 12 serves as an example of an aerial device detection system. In some instances, the secondary LIDAR system 12 is used in conjunction with other aerial device detection systems in order to identify an object and/or aerial device. Suitable aerial device detection systems for use in conjunction with the secondary LIDAR system 12 include, but are not limited to, radar, IR imaging, thermal imaging, and visible imaging. As a result, to determine if the object identified at determination block 402 is an aerial device and/or identify the type of aerial device, the LIDAR data processor 272 in the secondary LIDAR system 12 can use input(s) from other one or more aerial device detection systems in addition to the LIDAR data. Alternately, to determine if the object identified at determination block 402 is an aerial device and/or identify the type of aerial device, an aerial device detection system can use input(s) the LIDAR data from the secondary LIDAR system 12 in addition to data generated by the aerial device detection system. When the aerial device detection system includes one or more aerial surveillance systems in addition to the secondary LIDAR system 12, the one or more aerial surveillance systems can be positioned on the stage with the secondary LIDAR system 12 or can be positioned elsewhere.

The secondary LIDAR system 12 is optional and the aerial device detection system may exclude a secondary LIDAR system 12. For instance, an aerial surveillance system such as radar, one or more IR cameras, and/or one or more visible cameras can be a substitute for the secondary LIDAR system 12. One or more system output signals output from the aerial surveillance system can serve to define the identification region within the detection space. For instance, when the aerial surveillance system is radar, a radio frequency beam transmitted from the radar can define the identification region. When the aerial surveillance system is an IR or visible camera, IR or visible radiation emitted from the aerial surveillance system can define the identification region. In response to the identification of a subject scan zone, the one or more actuators can be operated so as to steer the one or more system output signals that define the identification region such that the identification region overlaps the subject scan zone as described above.

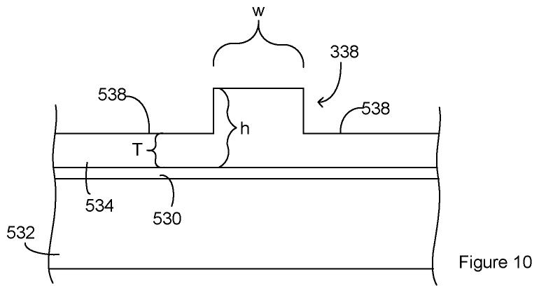

Suitable platforms for the LIDAR chips include, but are not limited to, silica, indium phosphide, and silicon-on-insulator wafers. FIG. 10 is a cross-section of a portion of a chip constructed from a silicon-on-insulator wafer. A silicon-on-insulator (SOI) wafer includes a buried layer 530 between a substrate 532 and a light-transmitting medium 534. In a silicon-on-insulator wafer, the buried layer 530 is silica while the substrate 532 and the light-transmitting medium 534 are silicon. The substrate 532 of an optical platform such as an SOI wafer can serve as the base for the entire LIDAR chip. For instance, the optical components shown on the LIDAR chips of FIG. 1A through FIG. 1C can be positioned on or over the top and/or lateral sides of the substrate 532. The silicon-on-insulator wafer includes a ridge 536 of the light-transmitting medium 534 extending upwards from slab regions of the light-transmitting medium 534. The ridge can define a waveguide on the silicon-on-insulator wafer.

The dimensions of the ridge waveguide are labeled in FIG. 10. For instance, the ridge has a width labeled w and a height labeled h. A thickness of the slab regions is labeled T. For LIDAR applications, these dimensions can be more important than other dimensions because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. All of a portion of the waveguides in the disclosed LIDAR systems can be constructed according to FIG. 10 but other constructions and/or platforms are possible.

Suitable electronics 24 can include, analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, at least a portion of the functions of the preliminary LS controller 26, the secondary LS controller 28, the ADDS controller 30 are executed by Field Programmable Gate Arrays (FPGAs), digital signal processors (DSPs), Application Specific Integrated Circuits, firmware, software, hardware, and combinations thereof. In some instances, at least a portion of the functions of the steering controller 38 and the response controller 40 are executed by Field Programmable Gate Arrays (FPGAs), digital signal processors (DSPs), Application Specific Integrated Circuits, firmware, software, hardware, and combinations thereof.

Light sensors that are interfaced with waveguides on a LIDAR chip can be a component that is separate from the chip and then attached to the chip. For instance, the light sensor can be a photodiode, or an avalanche photodiode. Examples of suitable light sensor components include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first auxiliary light sensor 218, the second auxiliary light sensor 220, the first light sensor 223, and the second light sensor 224.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10 2012; U.S. Pat. No. 8,242,432, issued Aug. 14 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the auxiliary light sensor 218, the second auxiliary light sensor 220, the first light sensor 223, and the second light sensor 224.

The light source 46 that is interfaced with the utility waveguide 48 can be a laser chip that is separate from the LIDAR chip and then attached to the LIDAR chip. For instance, the light source 46 can be a laser chip that is attached to the chip using a flip-chip arrangement. Use of flip-chip arrangements is suitable when the light source 46 is to be interfaced with a ridge waveguide on a chip constructed from silicon-on-insulator wafer. Alternately, the utility waveguide 48 can include an optical grating (not shown) such as a Bragg grating that acts as a reflector for an external cavity laser. In these instances, the light source 46 can include a gain element that is separate from the LIDAR chip and then attached to the LIDAR chip in a flip-chip arrangement. Examples of suitable interfaces between flip-chip gain elements and ridge waveguides on chips constructed from silicon-on-insulator wafer can be found in U.S. Pat. No. 9,705,278, issued on Jul. 11, 2017 and in U.S. Pat. No. 5,991,484 issued on Nov. 23 1999; each of which is incorporated herein in its entirety. When the light source 46 is a gain element or laser chip, the electronics 32 can change the frequency of the outgoing LIDAR signal by changing the level of electrical current applied to through the gain element or laser cavity.

The above LIDAR systems include multiple optical components such as a LIDAR chip, LIDAR adapters, light source, light sensors, waveguides, and amplifiers. In some instances, the LIDAR systems include one or more passive optical components in addition to the illustrated optical components or as an alternative to the illustrated optical components. The passive optical components can be solid-state components that exclude moving parts. Suitable passive optical components include, but are not limited to, lenses, mirrors, optical gratings, reflecting surfaces, splitters, demulitplexers, multiplexers, polarizers, polarization splitters, and polarization rotators. In some instances, the LIDAR systems include one or more active optical components in addition to the illustrated optical components or as an alternative to the illustrated optical components. Suitable active optical components include, but are not limited to, optical switches, phase tuners, attenuators, steerable mirrors, steerable lenses, tunable demulitplexers, tunable multiplexers.

Although the aerial device detection system is disclosed in the context of aerial devices, the aerial device detection system can be used in other applications. For instance, the aerial device detection system can serve as device detection system used to detect land-based objects, and sea-based objects.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output a system output signal, the system output signal having a divergence angle greater than or equal to 0.1°,
the LIDAR system being configured to receive a system return signal,
the system return signal including light from the system output signal that was reflected by an object located outside of the LIDAR system; and
light combiners that each combine light from the system return signal with light from a reference signal so as to generate a composite light signal beating at a beat frequency.

2. The system of claim 1, wherein the LIDAR system includes a LIDAR system controller configured to calculate a radial velocity between the LIDAR system and the object and to not calculate a distance between the LIDAR system and the object.

3. The system of claim 1, wherein the system output signal is a continuous wave.

4. A device detection system, comprising:
a LIDAR system configured to concurrently output multiple system output signals and scan the system output signals across a detection space,
the LIDAR system configured to calculate LIDAR data for multiple different scan zones within the detection space,
the LIDAR data for a scan zone indicating a radial velocity between an object in the scan zone and the LIDAR data,
the LIDAR system including a LIDAR data processor configured to process the LIDAR data so as to identify a subject one of the scan zones that contains an object;
an aerial surveillance system configured to transmit one or more system output signals such that the one or more system output signals transmitted from the aerial surveillance system define an identification region within the detection space; and
one or more actuators configured to move the aerial surveillance system so as to steer the identification region within the detection space; and
a steering controller configured such that in response to the identification of the subject scan zone the one or more actuators are operated so as to move the aerial surveillance system such that the identification region overlaps the subject scan zone.

5. A method of operating a device detection system, comprising:
causing a preliminary LIDAR system to concurrently output multiple system output signals and scan the system output signals across a detection space,
calculating preliminary LIDAR data for multiple different scan zones within the detection space,
the preliminary LIDAR data for a scan zone indicating a radial velocity between an object in the scan zone and the one or more LIDAR systems,
processing the preliminary LIDAR data so as to identify subject one of the scan zones that contains an object; and
transmitting one or more system output signals such that the one or more system output signals define an identification region within the detection space; and
in response to the identification of the subject scan zone, operating one or more actuators configured to move the aerial surveillance system such that the movement of the aerial surveillance system causes the identification region to overlap the subject scan zone.

6. A device detection system, comprising:
a preliminary LIDAR system configured to concurrently output multiple system output signals and scan the system output signals output from the preliminary LIDAR system across a detection space,
the preliminary LIDAR system configured to calculate preliminary LIDAR data for multiple different scan zones within the detection space,
the preliminary LIDAR data for a scan zone indicating a radial velocity between an object in the scan zone and the preliminary LIDAR data,
the preliminary LIDAR system including a LIDAR data processor configured to process the preliminary LIDAR data so as to identify a subject one of the scan zones that contains an object; and
a secondary LIDAR system configured to transmit one or more system output signals and to scan the one or more system output signals transmitted from the secondary LIDAR system across the subject scan zone,
the secondary LIDAR system configured to calculate LIDAR data for multiple data regions that each at least partially overlaps the subject scan zone,
the LIDAR data for each data region indicating the radial velocity and/or the distance between the object in the data region and the secondary LIDAR system.

7. A method of operating a device detection system, comprising:
causing a preliminary LIDAR system to concurrently output multiple system output signals and scan the system output signals across a detection space,
calculating preliminary LIDAR data for multiple different scan zones within the detection space,
the preliminary LIDAR data for a scan zone indicating a radial velocity between an object in the scan zone and the one or more LIDAR systems,
processing the preliminary LIDAR data so as to identify subject one of the scan zones that contains an object; and
causing a secondary LIDAR system to transmit one or more system output signals and to scan the one or more system output signals across the subject scan zone,
calculating LIDAR data for multiple data regions that each at least partially overlaps the subject scan zone,
the LIDAR data for a data region indicating the radial velocity and/or the distance between the object in the data region and the secondary LIDAR system.
